(19) United States
(12) Patent Application Publication
(10) Pub. No.: US 2023/0275686 A1
(43) Pub. Date: Aug. 31, 2023

(54) METHOD AND APPARATUS FOR PERFORMING CHANNEL CODING BY USER EQUIPMENT AND BASE STATION IN WIRELESS COMMUNICATION SYSTEM

(71) Applicant: LG ELECTRONICS INC., Seoul (JP)

(72) Inventors: Jongwoong SHIN, Seoul (KR); Byoung Hoon KIM, Seoul (KR); Bonghoe KIM, Seoul (KR)

(73) Assignee: LG ELECTRONICS INC., Seoul (KR)

(21) Appl. No.: 18/016,106

(22) PCT Filed: Jul. 13, 2020
(86) PCT No.: PCT/KR2020/009209

§ 371 Date: Jan. 13, 2023

(51) Int. Cl. H04L 1/00; H04B 7/06

(52) U.S. Cl. CPC H04L 1/0009; H04B 7/0626

(57) ABSTRACT

The present disclosure discloses methods for operation of user equipment and a base station in a wireless communication system, and an apparatus for supporting same. According to an embodiment applicable to the present disclosure, the method for operation of user equipment may comprise the steps of: performing learning on at least one of an encoding method and a decoding method for data transmission; and transmitting a signal on the basis of the learned at least one encoding method and decoding method.

### BACKGROUND

### Field

The present disclosure relates to a wireless communication system, and more particularly, to a method and apparatus for a terminal and a base station to transmit and receive a signal by performing channel coding in a wireless communication system.

In particular, a method and apparatus may be provided for a terminal and a base station to perform learning for channel coding and to perform channel coding based on learned information.

### Description of the Related Art

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide a method and apparatus for performing channel coding to transmit and receive a signal of a terminal and a base station.

The technical objects to be achieved in the present disclosure are not limited to the above-mentioned technical objects, and other technical objects that are not mentioned may be considered by those skilled in the art through the embodiments described below.

The present disclosure a method for operating user equipment (UE) in a wireless communication system, the method comprising: performing learning for at least one of an encoding scheme and a decoding scheme for data transmission; and transmitting a signal based on the at least one of the encoding scheme and the decoding scheme that are learned.

The present disclosure a user equipment (UE) operating in a wireless communication system, the UE comprising: at least one transmitter; at least one receiver, at least one processor; and at least one memory that is coupled with the at least one processor in an operable manner and stores instructions which, when being executed, enable the at least one processor to perform a specific operation, wherein the specific operation is configured to: perform learning for at least one of an encoding scheme and a decoding scheme for data transmission, and transmit a signal based on the at least one of the encoding scheme and the decoding scheme that are learned.

The present disclosure the user equipment communicates with at least one of a moving terminal, a network, and an autonomous vehicle apart from a vehicle including the user equipment.

In addition, the following items may be commonly applied to a method and apparatus for transmitting and receiving signals of a terminal and a base station to which the present disclosure is applied.

The present disclosure the UE operates based on UE capability, wherein, based on the UE being a first type UE, the UE operates based on a fixed channel coding scheme, wherein, based on the UE being a second type UE, the UE has a neural network but does not perform learning for channel coding, and wherein, based on the UE being a third type UE, the UE has a neural network and performs learning for channel coding.

The present disclosure based on the UE being the third type UE and being UE that transmits a signal, the UE receives, from a receiving end (Rx), at least one of channel state information (CSI) and resource information of the Rx, wherein the UE learns, based on the received information, at least one of the encoding scheme and the decoding scheme, and wherein the UE transmits the signal based on the learned encoding scheme.

The present disclosure the UE transmits information on the learned decoding scheme to the Rx, and wherein the Rx performs decoding for the signal, which is transmitted from the UE based on the learned encoding scheme, based on information on the learned decoding scheme.

The present disclosure based on the UE being the third type UE and being UE that receives a signal, the UE obtains CSI based on a reference signal and receives resource information of a transmitting end (Tx) from the Tx, wherein the UE learns, based on the resource information of the Tx and the CSI, at least one of the encoding scheme and the decoding scheme, and wherein the UE receives the signal based on the learned decoding scheme.

The present disclosure the UE transmits information on the learned encoding scheme to the Tx, and wherein the Tx performs encoding for data to be transmitted to the UE based on information on the learned encoding scheme.

The present disclosure based on the UE being the third type UE and being UE that transmits a signal and based on a receiving end (Rx) receiving the signal from the UE and using a fixed decoding scheme, the UE obtains CSI and information on the fixed decoding scheme, and wherein the UE performs learning for the encoding scheme based on at least one of the CSI and the information on the fixed decoding scheme.

The present disclosure the UE transmits the signal to the Rx based on the learned encoding scheme, and wherein the Rx decodes the received signal based on the fixed decoding scheme.

The present disclosure based on the UE being the third type UE and being UE that receives a signal and based on a transmitting end (Tx) transmitting the signal to the UE and using a fixed encoding scheme, the UE obtains CSI and information on the fixed encoding scheme, and wherein the UE performs learning for the decoding scheme based on at least one of the CSI and the information on the fixed encoding scheme.

The present disclosure the UE performs decoding for the received signal based on the learned decoding scheme, and wherein the Tx transmits the signal to the UE based on the fixed encoding scheme.

The present disclosure based on the UE being the third type UE and being coordinator UE, the UE obtains information on at least one of resource information of a Tx, resource information of a Rx, and CSI of the Tx and the Rx, and wherein, based on the obtained information, the UE learns at least one of an encoding scheme of the Tx and a decoding scheme of the Rx.

The present disclosure the UE transmits, to the Tx, information on the learned encoding scheme of the Tx, wherein the UE transmits, to the Rx, information on the learned decoding scheme, and wherein the Tx and the Rx perform data exchange based on the information obtained from the UE.

The above-described aspects of the present disclosure are only some of the preferred embodiments of the present disclosure, and various embodiments in which the technical features of the present disclosure are reflected are the detailed descriptions of the present disclosure to be detailed below by those of ordinary skill in the art. It can be derived and understood based on the description.

The following effects may be produced by embodiments based on the present disclosure.

According to the present disclosure, a terminal may reduce a learning time for channel coding.

According to the present disclosure, when a terminal performs learning for channel coding, the terminal may reduce wasted resources.

According to the present disclosure, a terminal may determine whether or not to perform learning for channel coding, based on terminal capability information.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a hand-held device applicable to the present disclosure.

FIG. 5 is a view showing an example of a car or an autonomous driving car applicable to the present disclosure.

FIG. 6 is a view showing an example of a mobility applicable to the present disclosure.

FIG. 7 is a view showing an example of an extended reality (XR) device applicable to the present disclosure.

FIG. 8 is a view showing an example of a robot applicable to the present disclosure.

FIG. 9 is a view showing an example of artificial intelligence (AI) device applicable to the present disclosure.

FIG. 10 is a view showing physical channels applicable to the present disclosure and a signal transmission method using the same.

FIG. 11 is a view showing the structure of a control plane and a user plane of a radio interface protocol applicable to the present disclosure.

FIG. 12 is a view showing a method of processing a transmitted signal applicable to the present disclosure.

FIG. 13 is a view showing the structure of a radio frame applicable to the present disclosure.

FIG. 14 is a view showing a slot structure applicable to the present disclosure.

FIG. 15 is a view showing an example of a communication structure providable in a 6th generation (6G) system applicable to the present disclosure.

FIG. 16 is a view showing an electromagnetic spectrum applicable to the present disclosure.

FIG. 17 is a view showing a THz communication method applicable to the present disclosure.

FIG. 18 is a view showing a THz wireless communication transceiver applicable to the present disclosure.

FIG. 19 is a view showing a THz signal generation method applicable to the present disclosure.

FIG. 20 is a view showing a wireless communication transceiver applicable to the present disclosure.

FIG. 21 is a view showing a transmitter structure applicable to the present disclosure.

FIG. 22 is a view showing a modulator structure applicable to the present disclosure.

FIG. 23 is a view showing a neural network applicable to the present disclosure.

FIG. 24 is a view showing an activation node in a neural network applicable to the present disclosure.

FIG. 25 is a view showing a method of calculating a gradient by using a chain rule applicable to the present disclosure.

FIG. 26 is a view showing a learning model based on a RNN applicable to the present disclosure.

FIG. 27 is a view showing an autoencoder applicable to the present disclosure.

FIG. 28 is a view showing a communication chain using an autoencoder that is applicable to the present disclosure.

FIG. 29 is a view showing a communication chain using a neural network that is applicable to the present disclosure.

FIG. 30 is a view showing a method of configuring an autoencoder at Tx that is applicable to the present disclosure.

FIG. 31 is a view showing a method of performing data transmission based on an autoencoder at Tx that is applicable to the present disclosure.

FIG. 32 is a view showing a method of configuring an autoencoder at Rx that is applicable to the present disclosure.

FIG. 33 is a view showing a method of performing data transmission based on an autoencoder at Rx that is applicable to the present disclosure.

FIG. 34 is a view showing a method of configuring an autoencoder at Rx that is applicable to the present disclosure.

FIG. 35 is a view showing a method of performing data transmission based on an autoencoder at Rx that is applicable to the present disclosure.

FIG. 36 is a view showing a method of configuring an autoencoder at Tx that is applicable to the present disclosure.

FIG. 37 is a view showing a method of performing data transmission based on an autoencoder at Tx that is applicable to the present disclosure.

FIG. 38 is a view showing a method of configuring an autoencoder at a coordinator that is applicable to the present disclosure.

FIG. 39 is a view showing a method of configuring an autoencoder at a coordinator that is applicable to the present disclosure.

FIG. 40 is a view showing a method of operating a terminal that is applicable to the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

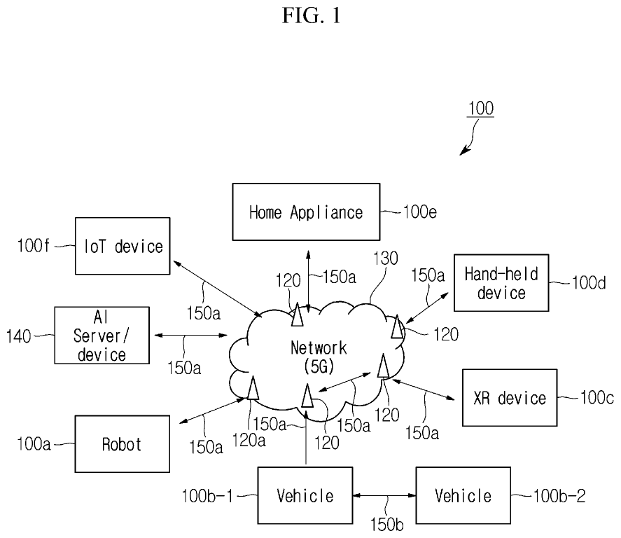

FIG. 1 is a view showing an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

Communication System Applicable to the Present Disclosure

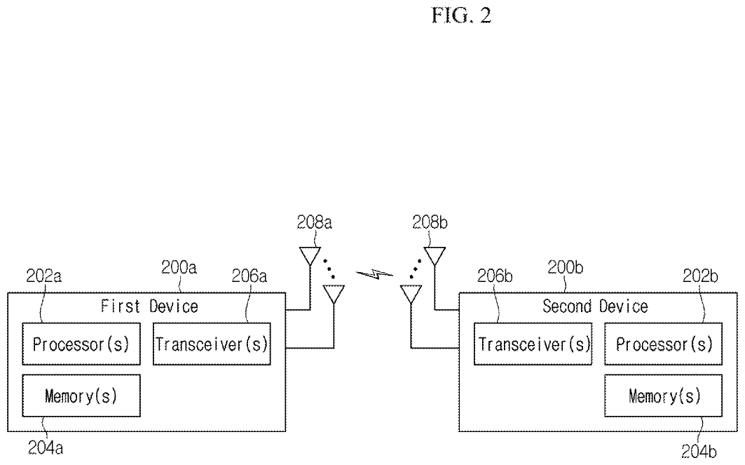

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

Structure of Wireless Device Applicable to the Present Disclosure

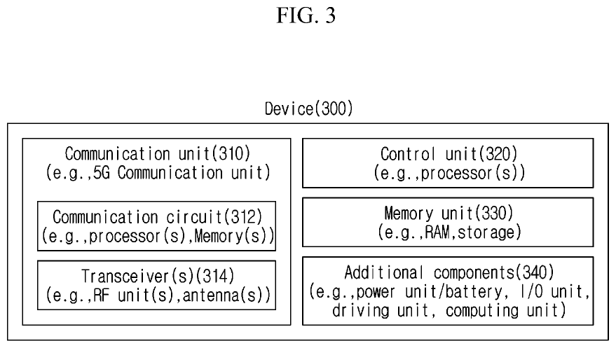

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 1000, a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof

Hand-Held Device Applicable to the Present Disclosure

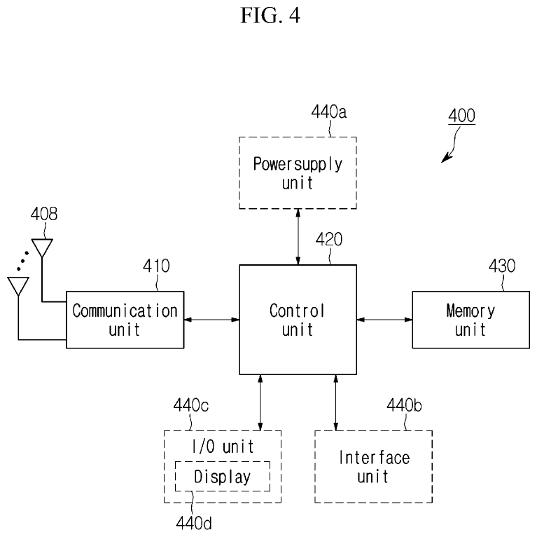

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

Type of Wireless Device Applicable to the Present Disclosure

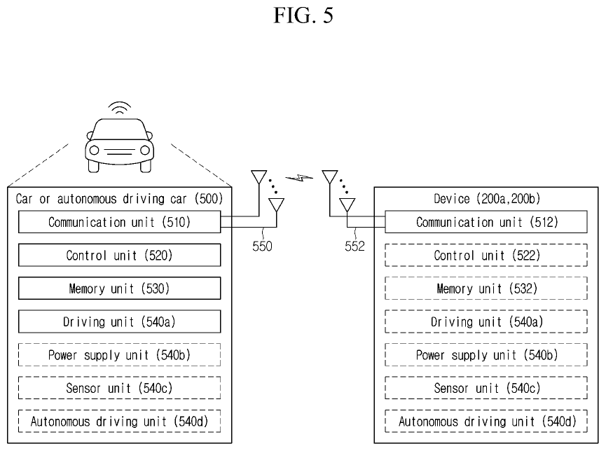

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU). The driving unit 540a may drive the car or autonomous driving car 500 on the ground. The driving unit 540a may include an engine, a motor, a power train, wheels, a brake, a steering device, etc. The power supply unit 540b may supply power to the car or autonomous driving car 500, and include a wired/wireless charging circuit, a battery, etc. The sensor unit 540c may obtain a vehicle state, surrounding environment information, user information, etc. The sensor unit 540c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 540d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 510 may receive map data, traffic information data, etc. from an external server. The autonomous driving unit 540d may generate an autonomous driving route and a driving plan based on the acquired data. The control unit 520 may control the driving unit 540a (e.g., speed/direction control) such that the car or autonomous driving car 500 moves along the autonomous driving route according to the driving plane. During autonomous driving, the communication unit 510 may aperiodically/periodically acquire latest traffic information data from an external server and acquire surrounding traffic information data from neighboring cars. In addition, during autonomous driving, the sensor unit 540c may acquire a vehicle state and surrounding environment information. The autonomous driving unit 540d may update the autonomous driving route and the driving plan based on newly acquired data/information. The communication unit 510 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

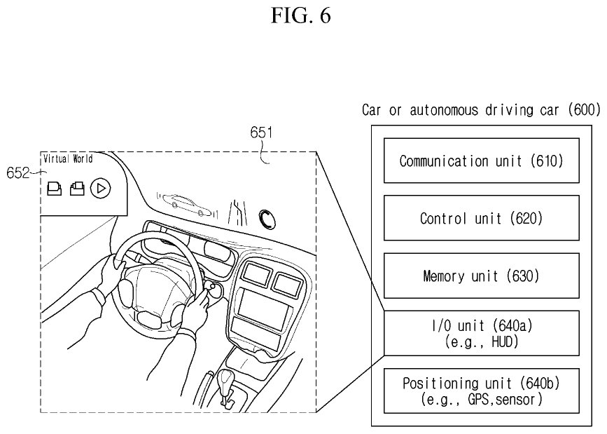

FIG. 6 is a view showing an example of a mobility applicable to the present disclosure.

Referring to FIG. 6, the mobility applied to the present disclosure may be implemented as at least one of a transportation means, a train, an aerial vehicle or a ship. In addition, the mobility applied to the present disclosure may be implemented in the other forms and is not limited to the above-described embodiments.

At this time, referring to FIG. 6, the mobility 600 may include a communication unit (transceiver) 610, a control unit (controller) 620, a memory unit (memory) 630, an input/output unit 640a and a positioning unit 640b. Here, the blocks 610 to 630/640a to 640b may corresponding to the blocks 310 to 330/340 of FIG. 3.

The communication unit 610 may transmit and receive signals (e.g., data, control signals, etc.) to and from external devices such as another mobility or a base station. The control unit 620 may control the components of the mobility 600 to perform various operations. The memory unit 630 may store data/parameters/programs/code/instructions supporting the various functions of the mobility 600. The input/output unit 640a may output AR/VR objects based on information in the memory unit 630. The input/output unit 640a may include a HUD. The positioning unit 640b may acquire the position information of the mobility 600. The position information may include absolute position information of the mobility 600, position information in a driving line, acceleration information, position information of neighboring vehicles, etc. The positioning unit 640b may include a global positioning system (GPS) and various sensors.

For example, the communication unit 610 of the mobility 600 may receive map information, traffic information, etc. from an external server and store the map information, the traffic information, etc. in the memory unit 630. The positioning unit 640b may acquire mobility position information through the GPS and the various sensors and store the mobility position information in the memory unit 630. The control unit 620 may generate a virtual object based on the map information, the traffic information, the mobility position information, etc., and the input/output unit 640a may display the generated virtual object in a glass window (651 and 652). In addition, the control unit 620 may determine whether the mobility 600 is normally driven in the driving line based on the mobility position information. When the mobility 600 abnormally deviates from the driving line, the control unit 620 may display a warning on the glass window of the mobility through the input/output unit 640a. In addition, the control unit 620 may broadcast a warning message for driving abnormality to neighboring mobilities through the communication unit 610. Depending on situations, the control unit 620 may transmit the position information of the mobility and information on driving/mobility abnormality to a related institution through the communication unit 610.

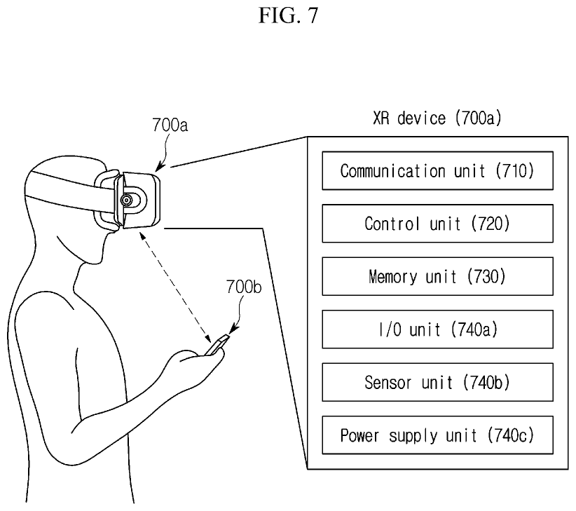

FIG. 7 is a view showing an example of an XR device applicable to the present disclosure. The XR device may be implemented as a HMD, a head-up display (HUD) provided in a vehicle, a television, a smartphone, a computer, a wearable device, a home appliance, a digital signage, a vehicle, a robot, etc.

Referring to FIG. 7, the XR device 700a may include a communication unit (transceiver) 710, a control unit (controller) 720, a memory unit (memory) 730, an input/output unit 740a, a sensor unit 740b and a power supply unit (power supply) 740c. Here, the blocks 710 to 730/740a to 740c may correspond to the blocks 310 to 330/340 of FIG. 3, respectively.

The communication unit 710 may transmit and receive signals (e.g., media data, control signals, etc.) to and from external devices such as another wireless device, a hand-held device or a media server. The media data may include video, image, sound, etc. The control unit 720 may control the components of the XR device 700a to perform various operations. For example, the control unit 720 may be configured to control and/or perform procedures such as video/image acquisition, (video/image) encoding, metadata generation and processing. The memory unit 730 may store data/parameters/programs/code/instructions necessary to drive the XR device 700a or generate an XR object.

The input/output unit 740a may acquire control information, data, etc. from the outside and output the generated XR object. The input/output unit 740a may include a camera, a microphone, a user input unit, a display, a speaker and/or a haptic module. The sensor unit 740b may obtain an XR device state, surrounding environment information, user information, etc. The sensor unit 740b may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar. The power supply unit 740c may supply power to the XR device 700a and include a wired/wireless charging circuit, a battery, etc.

For example, the memory unit 730 of the XR device 700a may include information (e.g., data, etc.) necessary to generate an XR object (e.g., AR/VR/MR object). The input/output unit 740a may acquire an instruction for manipulating the XR device 700a from a user, and the control unit 720 may drive the XR device 700a according to the driving instruction of the user. For example, when the user wants to watch a movie, news, etc. through the XR device 700a, the control unit 720 may transmit content request information to another device (e.g., a hand-held device 700b) or a media server through the communication unit 730. The communication unit 730 may download/stream content such as a movie or news from another device (e.g., the hand-held device 700b) or the media server to the memory unit 730. The control unit 720 may control and/or perform procedures such as video/image acquisition, (video/image) encoding, metadata generation/processing, etc. with respect to content, and generate/output an XR object based on information on a surrounding space or a real object acquired through the input/output unit 740a or the sensor unit 740b.

In addition, the XR device 700a may be wirelessly connected with the hand-held device 700b through the communication unit 710, and operation of the XR device 700a may be controlled by the hand-held device 700b. For example, the hand-held device 700b may operate as a controller for the XR device 700a. To this end, the XR device 700a may acquire three-dimensional position information of the hand-held device 700b and then generate and output an XR object corresponding to the hand-held device 700b.

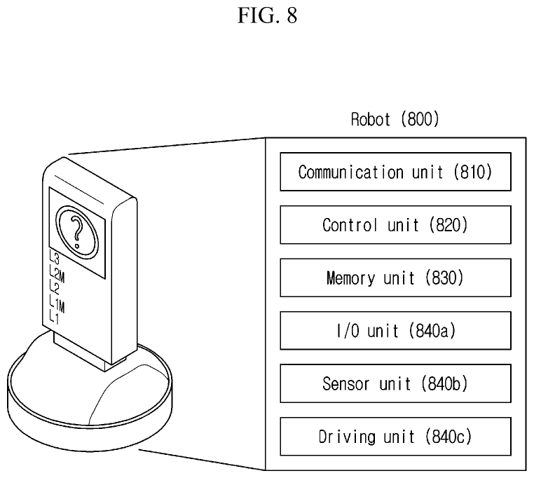

FIG. 8 is a view showing an example of a robot applicable to the present disclosure. For example, the robot may be classified into industrial, medical, household, military, etc. according to the purpose or field of use. At this time, referring to FIG. 8, the robot 800 may include a communication unit (transceiver) 810, a control unit (controller) 820, a memory unit (memory) 830, an input/output unit 840a, sensor unit 840b and a driving unit 840c. Here, blocks 810 to 830/840a to 840c may correspond to the blocks 310 to 330/340 of FIG. 3, respectively.

The communication unit 810 may transmit and receive signals (e.g., driving information, control signals, etc.) to and from external devices such as another wireless device, another robot or a control server. The control unit 820 may control the components of the robot 800 to perform various operations. The memory unit 830 may store data/parameters/programs/code/instructions supporting various functions of the robot 800. The input/output unit 840a may acquire information from the outside of the robot 800 and output information to the outside of the robot 800. The input/output unit 840a may include a camera, a microphone, a user input unit, a display, a speaker and/or a haptic module.

The sensor unit 840b may obtain internal information, surrounding environment information, user information, etc. of the robot 800. The sensor unit 840b may include a proximity sensor, an illumination sensor, an acceleration sensor, a magnetic sensor, a gyro sensor, an inertia sensor, an infrared (IR) sensor, a finger scan sensor, an ultrasonic sensor, an optical sensor, a microphone and/or a radar.

The driving unit 840c may perform various physical operations such as movement of robot joints. In addition, the driving unit 840c may cause the robot 800 to run on the ground or fly in the air. The driving unit 840c may include an actuator, a motor, wheels, a brake, a propeller, etc.

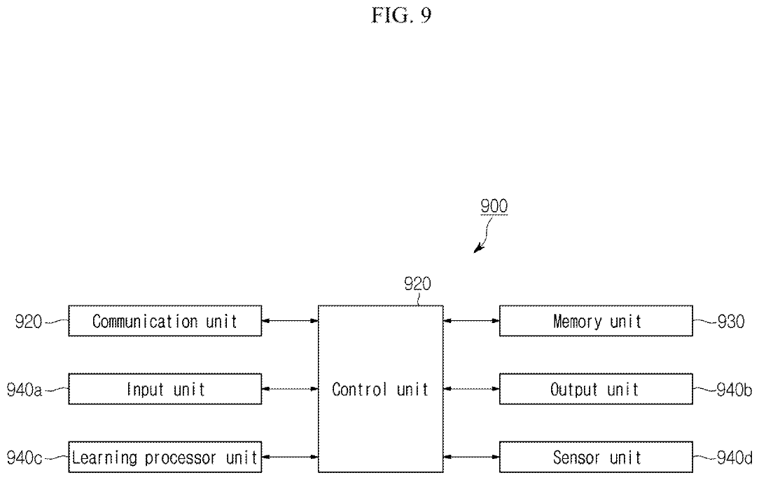

FIG. 9 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 9, the AI device 900 may include a communication unit (transceiver) 910, a control unit (controller) 920, a memory unit (memory) 930, an input/output unit 940a/940b, a leaning processor unit (learning processor) 940c and a sensor unit 940d. The blocks 910 to 930/940a to 940d may correspond to the blocks 310 to 330/340 of FIG. 3, respectively.

The communication unit 910 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 910 may transmit information in the memory unit 930 to an external device or transfer a signal received from the external device to the memory unit 930.

The control unit 920 may determine at least one executable operation of the AI device 900 based on information determined or generated using a data analysis algorithm or a machine learning algorithm. In addition, the control unit 920 may control the components of the AI device 900 to perform the determined operation. For example, the control unit 920 may request, search for, receive or utilize the data of the learning processor unit 940c or the memory unit 930, and control the components of the AI device 900 to perform predicted operation or operation, which is determined to be desirable, of at least one executable operation. In addition, the control unit 920 may collect history information including operation of the AI device 900 or user's feedback on the operation and store the history information in the memory unit 930 or the learning processor unit 940c or transmit the history information to the AI server (FIG. 1, 140). The collected history information may be used to update a learning model.

The memory unit 930 may store data supporting various functions of the AI device 900. For example, the memory unit 930 may store data obtained from the input unit 940a, data obtained from the communication unit 910, output data of the learning processor unit 940c, and data obtained from the sensing unit 940. In addition, the memory unit 930 may store control information and/or software code necessary to operate/execute the control unit 920.

The input unit 940a may acquire various types of data from the outside of the AI device 900. For example, the input unit 940a may acquire learning data for model learning, input data, to which the learning model will be applied, etc. The input unit 940a may include a camera, a microphone and/or a user input unit. The output unit 940b may generate video, audio or tactile output. The output unit 940b may include a display, a speaker and/or a haptic module. The sensing unit 940 may obtain at least one of internal information of the AI device 900, the surrounding environment information of the AI device 900 and user information using various sensors. The sensing unit 940 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 940c may train a model composed of an artificial neural network using training data. The learning processor unit 940c may perform AI processing along with the learning processor unit of the AI server (FIG. 1, 140). The learning processor unit 940c may process information received from an external device through the communication unit 910 and/or information stored in the memory unit 930. In addition, the output value of the learning processor unit 940c may be transmitted to the external device through the communication unit 910 and/or stored in the memory unit 930.

Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

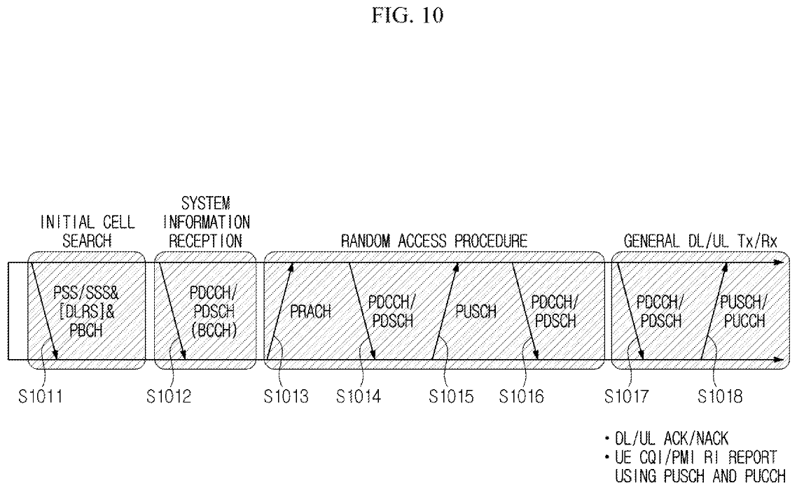

FIG. 10 is a view showing physical channels applicable to the present disclosure and a signal transmission method using the same.

The UE which is turned on again in a state of being turned off or has newly entered a cell performs initial cell search operation in step S1011 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S1012, thereby acquiring more detailed system information.

Thereafter, the UE may perform a random access procedure such as steps S1013 to S1016 in order to complete access to the base station. To this end, the UE may transmit a preamble through a physical random access channel (PRACH) (S1013) and receive a random access response (RAR) to the preamble through a physical downlink control channel and a physical downlink shared channel corresponding thereto (S1014). The UE may transmit a physical uplink shared channel (PUSCH) using scheduling information in the RAR (S1015) and perform a contention resolution procedure such as reception of a physical downlink control channel signal and a physical downlink shared channel signal corresponding thereto (S1016).

The UE, which has performed the above-described procedures, may perform reception of a physical downlink control channel signal and/or a physical downlink shared channel signal (S1017) and transmission of a physical uplink shared channel (PUSCH) signal and/or a physical uplink control channel (PUCCH) signal (S1018) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

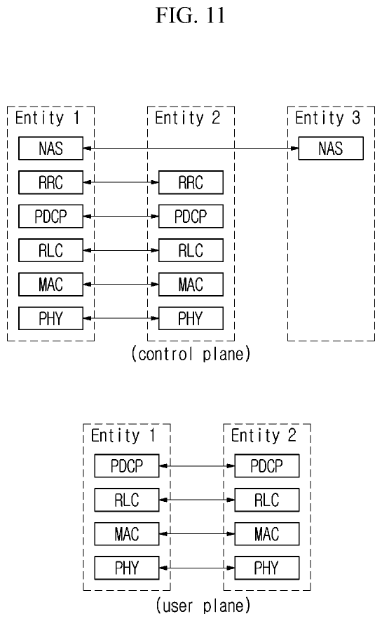

FIG. 11 is a view showing the structure of a control plane and a user plane of a radio interface protocol applicable to the present disclosure.

Referring to FIG. 11, Entity 1 may be a user equipment (UE). At this time, the UE may be at least one of a wireless device, a hand-held device, a vehicle, a mobility, an XR device, a robot or an AI device, to which the present disclosure is applicable in FIGS. 1 to 9. In addition, the UE refers to a device, to which the present disclosure is applicable, and is not limited to a specific apparatus or device.

Entity 2 may be a base station. At this time, the base station may be at least one of an eNB, a gNB or an ng-eNB. In addition, the base station may refer to a device for transmitting a downlink signal to a UE and is not limited to a specific apparatus or device. That is, the base station may be implemented in various forms or types and is not limited to a specific form.

Entity 3 may be a device for performing a network apparatus or a network function. At this time, the network apparatus may be a core network node (e.g., mobility management entity (MME) for managing mobility, an access and mobility management function (AMF), etc. In addition, the network function may mean a function implemented in order to perform a network function. Entity 3 may be a device, to which a function is applied. That is, Entity 3 may refer to a function or device for performing a network function and is not limited to a specific device.

A control plane refers to a path used for transmission of control messages, which are used by the UE and the network to manage a call. A user plane refers to a path in which data generated in an application layer, e.g. voice data or Internet packet data, is transmitted. At this time, a physical layer which is a first layer provides an information transfer service to a higher layer using a physical channel. The physical layer is connected to a media access control (MAC) layer of a higher layer via a transmission channel. At this time, data is transmitted between the MAC layer and the physical layer via the transmission channel. Data is also transmitted between a physical layer of a transmitter and a physical layer of a receiver via a physical channel. The physical channel uses time and frequency as radio resources.

The MAC layer which is a second layer provides a service to a radio link control (RLC) layer of a higher layer via a logical channel. The RLC layer of the second layer supports reliable data transmission. The function of the RLC layer may be implemented by a functional block within the MAC layer. A packet data convergence protocol (PDCP) layer which is the second layer performs a header compression function to reduce unnecessary control information for efficient transmission of an Internet protocol (IP) packet such as an IPv4 or IPv6 packet in a radio interface having relatively narrow bandwidth. A radio resource control (RRC) layer located at the bottommost portion of a third layer is defined only in the control plane. The RRC layer serves to control logical channels, transmission channels, and physical channels in relation to configuration, re-configuration, and release of radio bearers. A radio bearer (RB) refers to a service provided by the second layer to transmit data between the UE and the network. To this end, the RRC layer of the UE and the RRC layer of the network exchange RRC messages. A non-access stratum (NAS) layer located at a higher level of the RRC layer performs functions such as session management and mobility management. One cell configuring a base station may be set to one of various bandwidths to provide a downlink or uplink transmission service to several UEs. Different cells may be set to provide different bandwidths. Downlink transmission channels for transmitting data from a network to a UE may include a broadcast channel (BCH) for transmitting system information, a paging channel (PCH) for transmitting paging messages, and a DL shared channel (SCH) for transmitting user traffic or control messages. Traffic or control messages of a DL multicast or broadcast service may be transmitted through the DL SCH or may be transmitted through an additional DL multicast channel (MCH). Meanwhile, UL transmission channels for data transmission from the UE to the network include a random access channel (RACH) for transmitting initial control messages and a UL SCH for transmitting user traffic or control messages. Logical channels, which are located at a higher level of the transmission channels and are mapped to the transmission channels, include a broadcast control channel (BCCH), a paging control channel (PCCH), a common control channel (CCCH), a multicast control channel (MCCH), and a multicast traffic channel (MTCH).

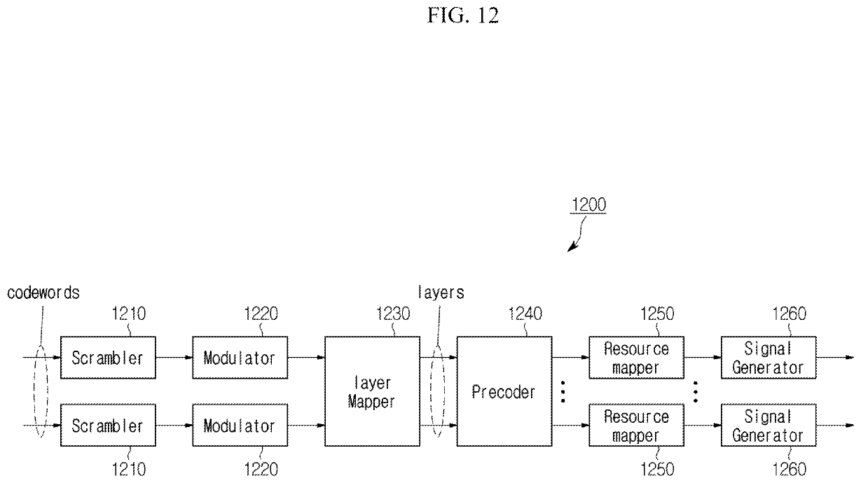

FIG. 12 is a view showing a method of processing a transmitted signal applicable to the present disclosure. For example, the transmitted signal may be processed by a signal processing circuit. At this time, a signal processing circuit 1200 may include a scrambler 1210, a modulator 1220, a layer mapper 1230, a precoder 1240, a resource mapper 1250, and a signal generator 1260. At this time, for example, the operation/function of FIG. 12 may be performed by the processors 202a and 202b and/or the transceiver 206a and 206b of FIG. 2. In addition, for example, the hardware element of FIG. 12 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 1210 to 1250 may be implemented in the processors 202a and 202b of FIG. 2 and a block 1260 may be implemented in the transceivers 206a and 206b of FIG. 2, without being limited to the above-described embodiments.

A codeword may be converted into a radio signal through the signal processing circuit 1200 of FIG. 12. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 10. Specifically, the codeword may be converted into a bit sequence scrambled by the scrambler 1210. The scramble sequence used for scramble is generated based in an initial value and the initial value may include ID information of a wireless device, etc. The scrambled bit sequence may be modulated into a modulated symbol sequence by the modulator 1220. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 1230. Modulation symbols of each transport layer may be mapped to corresponding antenna port(s) by the precoder 1240 (precoding). The output z of the precoder 1240 may be obtained by multiplying the output y of the layer mapper 1230 by an N*M precoding matrix W. Here, N may be the number of antenna ports and M may be the number of transport layers. Here, the precoder 1240 may perform precoding after transform precoding (e.g., discrete Fourier transform (DFT)) for complex modulation symbols. In addition, the precoder 1240 may perform precoding without performing transform precoding.

The resource mapper 1250 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 1260 may generate a radio signal from the mapped modulation symbols, and the generated radio signal may be transmitted to another device through each antenna. To this end, the signal generator 1260 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 1210 to 1260 of FIG. 12. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

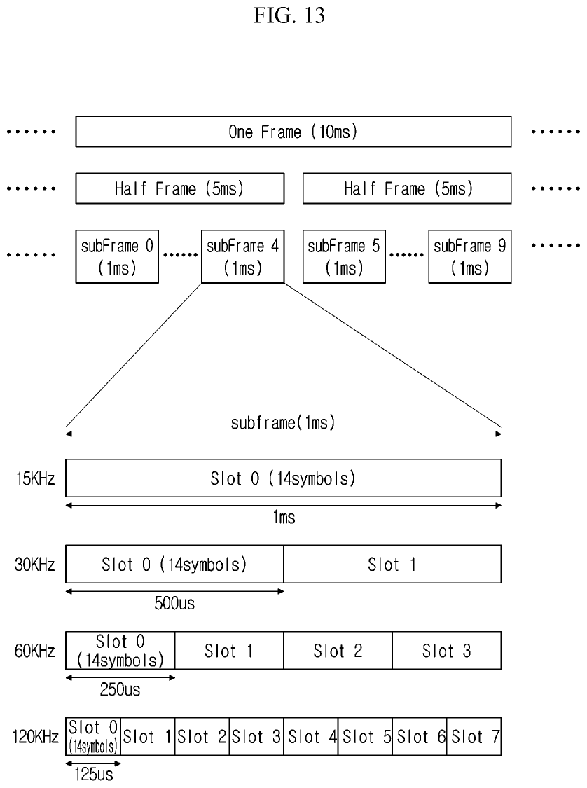

FIG. 13 is a view showing the structure of a radio frame applicable to the present disclosure.

UL and DL transmission based on an NR system may be based on the frame shown in FIG. 13. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | N_{symb}^{slot} | Nₛₗₒₜ^{frame, μ} | Nₛₗₒₜ^{subframe, μ} |
|---|---|---|---|
| 2 | 12 | 40 | 4 |

In Tables 1 and 2 above, Nslotsymb may indicate the number of symbols in a slot, Nframe,μslot may indicate the number of slots in a frame, and Nsubframe,μslot may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| EZE latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

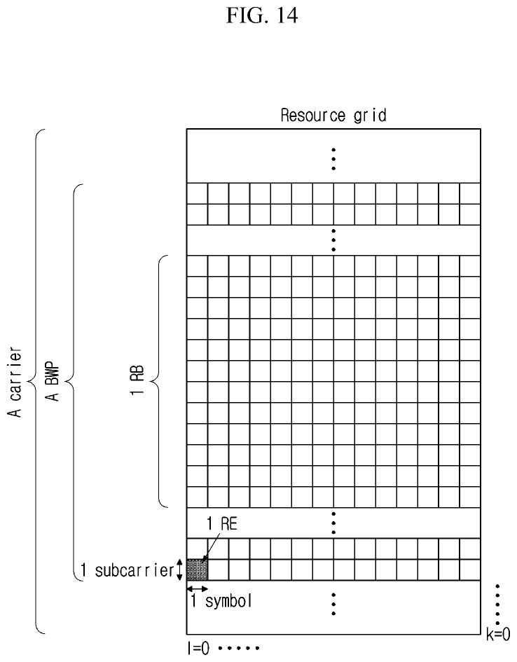

FIG. 14 is a view showing a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

6G Communication System

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

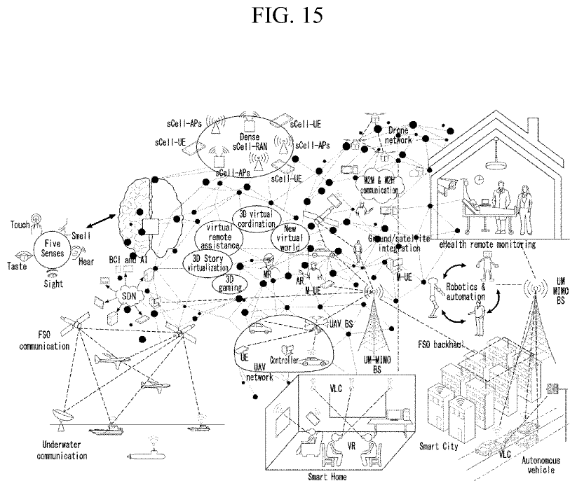

FIG. 15 is a view showing an example of a communication structure providable in a 6G system applicable to the present disclosure.

Referring to FIG. 15, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

Core Implementation Technology of 6G System
Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

Terahertz (THz) Communication

THz communication is applicable to the 6G system. For example, a data rate may increase by increasing bandwidth. This may be performed by using sub-THz communication with wide bandwidth and applying advanced massive MIMO technology.

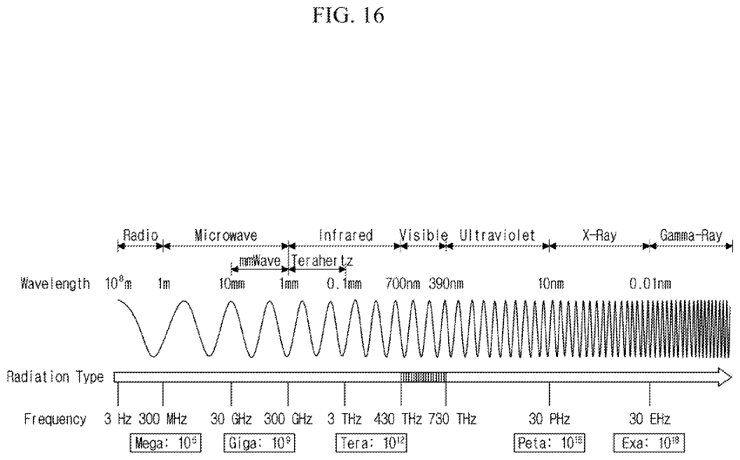

FIG. 16 is a view showing an electromagnetic spectrum applicable to the present disclosure. For example, referring to FIG. 16, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

Optical Wireless Technology

Optical wireless communication (OWC) technology is planned for 6G communication in addition to RF based communication for all possible device-to-access networks. This network is connected to a network-to-backhaul/fronthaul network connection. OWC technology has already been used since 4G communication systems but will be more widely used to satisfy the requirements of the 6G communication system. OWC technologies such as light fidelity/visible light communication, optical camera communication and free space optical (FSO) communication based on wide band are well-known technologies. Communication based on optical wireless technology may provide a very high data rate, low latency and safe communication. Light detection and ranging (LiDAR) may also be used for ultra high resolution 3D mapping in 6G communication based on wide band.

FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

Massive MIMO Technology

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

Blockchain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

3D Networking

The 6G system integrates terrestrial and public networks to support vertical expansion of user communication. A 3D BS will be provided through low-orbit satellites and UAVs. Adding new dimensions in terms of altitude and related degrees of freedom makes 3D connections significantly different from existing 2D networks.

Quantum Communication

In the context of the 6G network, unsupervised reinforcement learning of the network is promising. The supervised learning method cannot label the vast amount of data generated in 6G. Labeling is not required for unsupervised learning. Thus, this technique can be used to autonomously build a representation of a complex network. Combining reinforcement learning with unsupervised learning may enable the network to operate in a truly autonomous way.

Unmanned Aerial Vehicle

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

Cell-Free Communication

The tight integration of multiple frequencies and heterogeneous communication technologies is very important in the 6G system. As a result, a user can seamlessly move from network to network without having to make any manual configuration in the device. The best network is automatically selected from the available communication technologies. This will break the limitations of the cell concept in wireless communication. Currently, user movement from one cell to another cell causes too many handovers in a high-density network, and causes handover failure, handover delay, data loss and ping-pong effects. 6G cell-free communication will overcome all of them and provide better QoS. Cell-free communication will be achieved through multi-connectivity and multi-tier hybrid technologies and different heterogeneous radios in the device.

Wireless Information and Enemy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

Integration of Sensing and Communication

An autonomous wireless network is a function for continuously detecting a dynamically changing environment state and exchanging information between different nodes. In 6G, sensing will be tightly integrated with communication to support autonomous systems.

Integration of Access Backhaul Network

In 6G, the density of access networks will be enormous. Each access network is connected by optical fiber and backhaul connection such as FSO network. To cope with a very large number of access networks, there will be a tight integration between the access and backhaul networks.

Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

Bit Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

Large Intelligent Surface (LIS)

In the case of the THz band signal, since the straightness is strong, there may be many shaded areas due to obstacles. By installing the LIS near these shaded areas, LIS technology that expands a communication area, enhances communication stability, and enables additional optional services becomes important. The LIS is an artificial surface made of electromagnetic materials, and can change propagation of incoming and outgoing radio waves. The LIS can be viewed as an extension of massive MIMO, but differs from the massive MIMO in array structures and operating mechanisms. In addition, the LIS has an advantage such as low power consumption, because this operates as a reconfigurable reflector with passive elements, that is, signals are only passively reflected without using active RF chains. In addition, since each of the passive reflectors of the LIS must independently adjust the phase shift of an incident signal, this may be advantageous for wireless communication channels. By properly adjusting the phase shift through an LIS controller, the reflected signal can be collected at a target receiver to boost the received signal power.

THz Wireless Communication

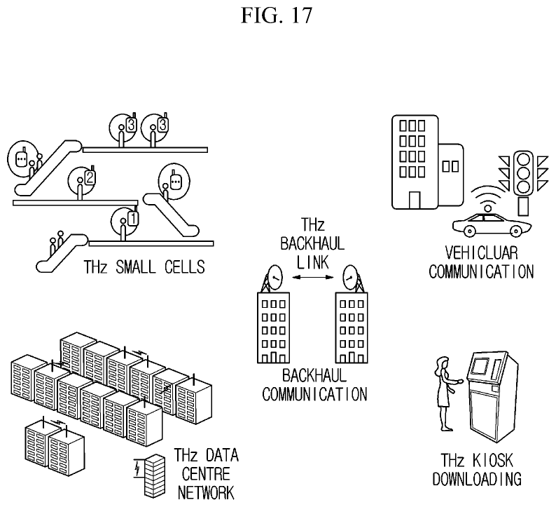

FIG. 17 is a view showing a THz communication method applicable to the present disclosure.

Referring to FIG. 17, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

In addition, the photon energy of the THz wave is only a few meV and thus is harmless to the human body. A frequency band which will be used for THz wireless communication may be a D-band (110 GHz to 170 GHz) or a H-band (220 GHz to 325 GHz) band with low propagation loss due to molecular absorption in air. Standardization discussion on THz wireless communication is being discussed mainly in IEEE 802.15 THz working group (WG), in addition to 3GPP, and standard documents issued by a task group (TG) of IEEE 802.15 (e.g., TG3d, TG3e) specify and supplement the description of this disclosure. The THz wireless communication may be applied to wireless cognition, sensing, imaging, wireless communication, and THz navigation.

Specifically, referring to FIG. 17, a THz wireless communication scenario may be classified into a macro network, a micro network, and a nanoscale network. In the macro network, THz wireless communication may be applied to vehicle-to-vehicle (V2V) connection and backhaul/fronthaul connection. In the micro network, THz wireless communication may be applied to near-field communication such as indoor small cells, fixed point-to-point or multi-point connection such as wireless connection in a data center or kiosk downloading. Table 5 below shows an example of technology which may be used in the THz wave.

TABLE 5

| | |
|---|---|
| Transceivers Device | Available immature: UTC-PD, RTD and SBD |
| Modulation and | Low order modulation techniques (OOK, QPSK), |
| coding | LDPC, Reed Soloman, Hamming, Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

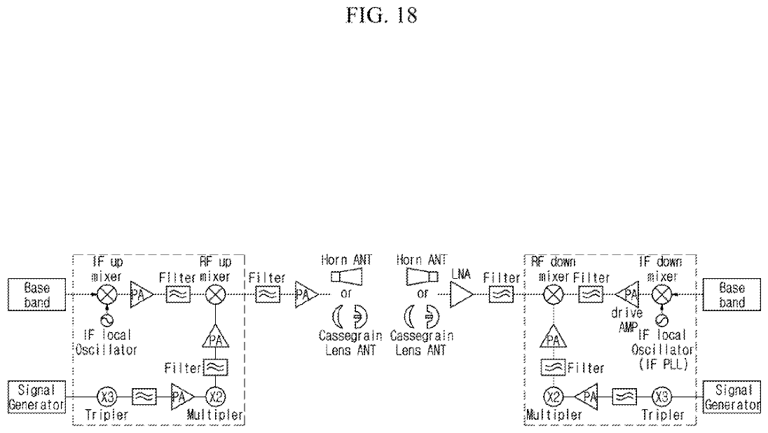

FIG. 18 is a view showing a THz wireless communication transceiver applicable to the present disclosure.

Referring to FIG. 18, THz wireless communication may be classified based on the method of generating and receiving THz. The THz generation method may be classified as an optical component or electronic component based technology.

At this time, the method of generating THz using an electronic component includes a method using a semiconductor component such as a resonance tunneling diode (RTD), a method using a local oscillator and a multiplier, a monolithic microwave integrated circuit (MMIC) method using a compound semiconductor high electron mobility transistor (HEMT) based integrated circuit, and a method using a Si-CMOS-based integrated circuit. In the case of FIG. 18, a multiplier (doubler, tripler, multiplier) is applied to increase the frequency, and radiation is performed by an antenna through a subharmonic mixer. Since the THz band forms a high frequency, a multiplier is essential. Here, the multiplier is a circuit having an output frequency which is N times an input frequency, and matches a desired harmonic frequency, and filters out all other frequencies. In addition, beamforming may be implemented by applying an array antenna or the like to the antenna of FIG. 18. In FIG. 18, IF represents an intermediate frequency, a tripler and a multiplier represents a multiplier, PA represents a power amplifier, and LNA represents a low noise amplifier, and PLL represents a phase-locked loop.

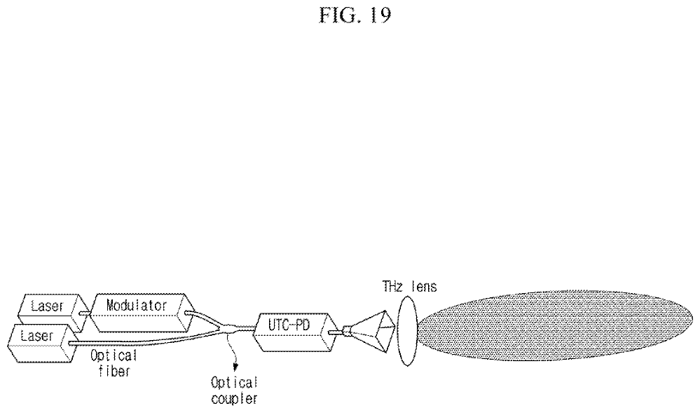

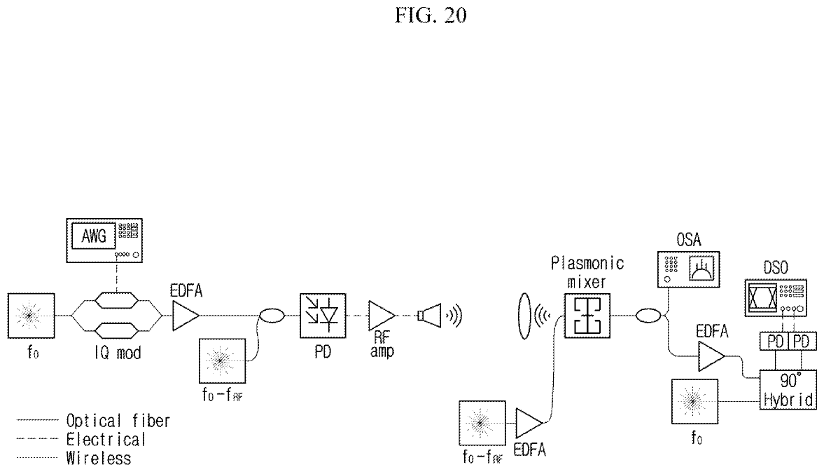

FIG. 19 is a view showing a THz signal generation method applicable to the present disclosure. FIG. 20 is a view showing a wireless communication transceiver applicable to the present disclosure.

Referring to FIGS. 19 and 20, the optical component-based THz wireless communication technology means a method of generating and modulating a THz signal using an optical component. The optical component-based THz signal generation technology refers to a technology that generates an ultrahigh-speed optical signal using a laser and an optical modulator, and converts it into a THz signal using an ultrahigh-speed photodetector. This technology is easy to increase the frequency compared to the technology using only the electronic component, can generate a high-power signal, and can obtain a flat response characteristic in a wide frequency band. In order to generate the THz signal based on the optical component, as shown in FIG. 19, a laser diode, a broadband optical modulator, and an ultrahigh-speed photodetector are required. In the case of FIG. 19, the light signals of two lasers having different wavelengths are combined to generate a THz signal corresponding to a wavelength difference between the lasers. In FIG. 19, an optical coupler refers to a semiconductor component that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 20, an erbium-doped fiber amplifier (EDFA) represents an optical fiber amplifier to which erbium is added, a photo detector (PD) represents a semiconductor component capable of converting an optical signal into an electrical signal, and OSA represents an optical sub assembly in which various optical communication functions (e.g., photoelectric conversion, electrophotic conversion, etc.) are modularized as one component, and DSO represents a digital storage oscilloscope.

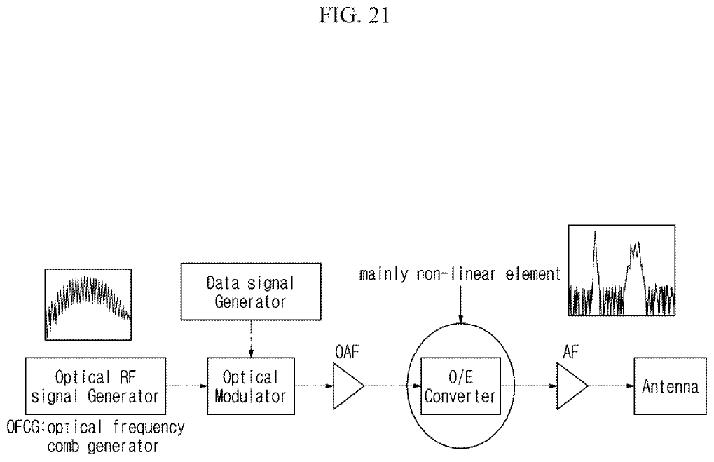

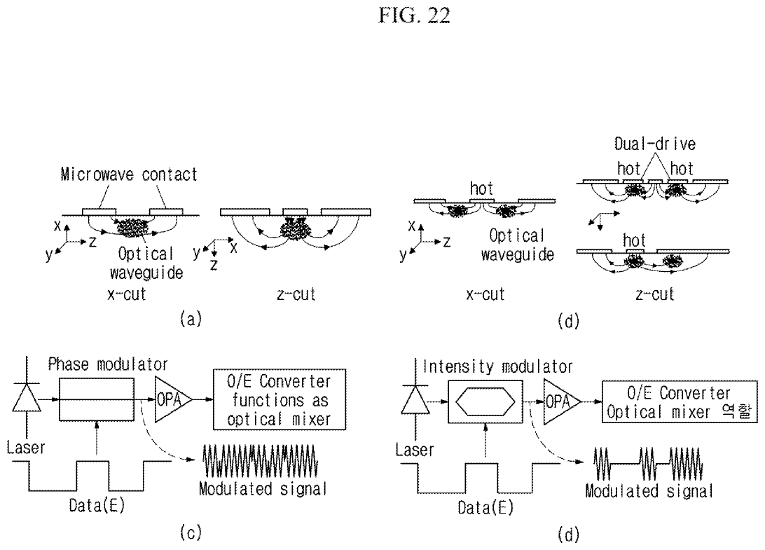

FIG. 21 is a view showing a transmitter structure applicable to the present disclosure. FIG. 22 is a view showing a modulator structure applicable to the present disclosure.

Referring to FIGS. 21 and 22, generally, the optical source of the laser may change the phase of a signal by passing through the optical wave guide. At this time, data is carried by changing electrical characteristics through microwave contact or the like. Thus, the optical modulator output is formed in the form of a modulated waveform. A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the component.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

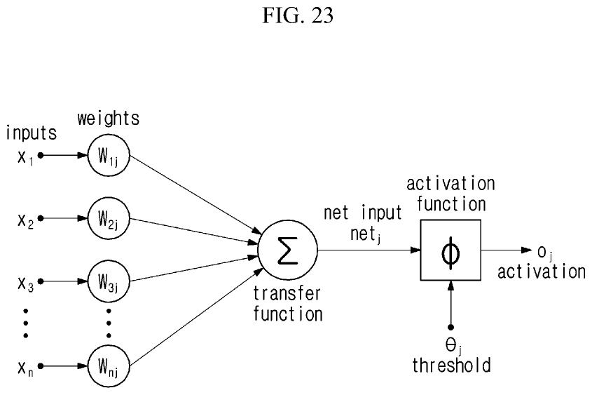

FIG. 23 is a view showing a neural network applicable to the present disclosure.

As described above, the artificial intelligence (AI) technology may be introduced to a new communication system (e.g., 6G system). Herein, the AI may utilizes a neural network as a machine learning model that imitates human brain.

Specifically, a device may process arithmetic operations of 0 and 1 and, based on this, execute an operation and communication. Herein, the technical advances enable devices to process more arithmetic operations in a shorter time and with lower power consumption. On the other hand, people cannot do arithmetic operations as fast as devices. Human brains may not have been made only to process arithmetic operations as fast as possible. However, people can perform other operations like recognition and natural language processing. Herein, the above-described operations are intended to process things beyond arithmetic operations, and devices cannot currently process those things at a level achieved by human brains. Accordingly, it may be worthwhile to consider creating a system that makes devices achieve human-level performance in such areas as natural language processing and computer vision. In consideration of what is described above, a neural network may be a model based on the idea that human brain can be imitated.

Herein, a neural network may be a simple mathematical model built upon the above-described motivation. Herein, the human brain may consist of an enormous number of neurons and synapses connecting neurons. In addition, according to how each neuron is activated, an action may be taken by selecting whether or not other neurons are activated. Based on the above-described facts, a neural network may define a mathematical model.

As an example, it is possible to generate a network in which neurons are nodes and synapses connecting the neurons are edges. At this time, each synapse may have a different importance. That is, a weight may be defined separately for each edge.

As an example, referring to FIG. 23, a neural network may be a directed graph. That is, information propagation may be fixed in a single direction. As an example, in case there is an undirected edge or identical directed edges are given in both directions, information propagation may occur recursively. Accordingly, the neural network may have complex results. As an example, a neural network as described above may be a recurrent neural network (RNN). Herein, since a RNN has an effect of storing past data, it has frequently used to process sequential data like voice recognition in recent years. In addition, a multi-layer perception (MLP) architecture may be a directed simple graph.

Herein, there is no connection in a same layer. That is, there is neither self-loop and nor a parallel edge, and an edge may exist only between layers. In addition, an edge may exist only between layers adjacent to each other. That is, in FIG. 23, there is no edge connecting a first layer and a fourth layer. As an example, unless there is a special remark on a layer, it may be the above-described MLP but is not limited thereto. In the above-described case, information propagation may occur only in a forward direction. Accordingly, the above-described network may be a feed-forward network but is not limited thereto.

In addition, as an example, in an actual brain, different neurons may be activated, and a corresponding result may be delivered to a next neuron. In the above-described method, a neuron making a final decision may activate a result value and the process information. Herein, if the above-described method is changed into a mathematical model, an activation condition for input data may be expressed by a function. Herein, the above-described function may be referred to as an activate function.

As an example, the simplest activate function may be a function that aggregates all the input data and then compares the sum with a threshold. As an example, in case a sum of all input data exceeds a specific value, a device may process information by activation. On the other hand, in case a sum of all input data does not exceed a specific value, a device may process information by inactivation.

As another example, there may be various forms of activate functions. As an example, for convenience of explanation, Formula 1 may be defined. Herein, in Formula 1, not only a weight but also a bias need to be considered, and the weight and the bias may be expressed as in Formula 2. However, since a bias (b) and a weight (w) are almost identical with each other, the description below will consider only the weight. However, the present disclosure is not limited thereto. As an example, since w0 becomes a bias by adding x0 that always has a value of 1, a virtual input may be assumed so that the weight and the bias can be treated to be identical, but the present disclosure is not limited to the above-described embodiment.

t=Σᵢwᵢxᵢ [Formula 1]

t=Σᵢwᵢxᵢ+bᵢ [Formula 2]

A model based on what is described above may first define a shape of a network consisting of a node and an edge. Then, the model may define an activate function for each node. In addition, a parameter adjusting the model has a role of a weight of edge, and a mathematical model may be trained to find a most appropriate weight. As an example, Formula 3 to Formula 6 below may be one form of the above-described activate function but are not limited to a specific form.

$$Sigmoid function : f ( t ) = \frac{1}{1 + {e}^{- t}} \qquad [ Formula 3 ]$$

$$Tanh function \text{::} f ( t ) = \frac{1 - {e}^{- t}}{1 + {e}^{- t}} \qquad [ Formula 4 ]$$

$$Absolute function : f ( t ) = ‖ t \vert \vert \qquad [ Formula 5 ]$$

$$ReLu function : f ( t ) = max ( 0 , t ) \qquad [ Formula 6 ]$$

In addition, as an example, in case a mathematical model is trained, it is necessary to assume the every parameter is determined and to check how a neural network interfaces with a result. Herein, the neural network may first determine, for a given input, activation of a next layer and then determine activation of a next layer according to the determined activation. Based on the above-described method, an interface may be determined by checking a result of a last decision layer.

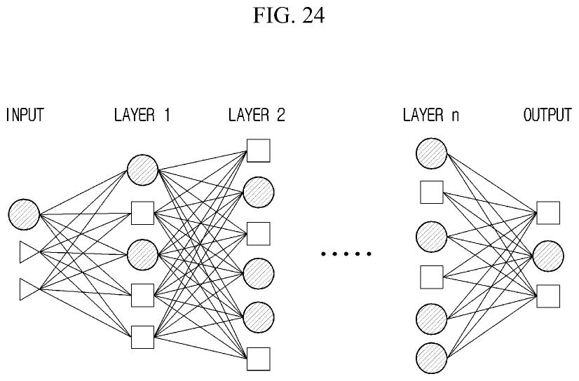

As an example, FIG. 24 is a view showing an activation node in a neural network applicable to the present disclosure. Referring to FIG. 24, when classification is performed, after as many decision nodes as the number of classes to be classified are generated in a last layer, one of the nodes may be activated to select a value.

In addition, as an example, it is possible to consider a case in which activate functions of a neural network is non-linear and the functions forms a complicated configuration by becoming layers for each other. Herein, weight optimization of a neural network may be non-convex optimization. Accordingly, it may be impossible to find a global optimum of parameters of the neural network. In consideration of what is described above, a method of converging to a suitable value may be used by the gradient descent method. As an example, every optimization problem can be solved only when a target function is defined.

In a neural network, a loss function may be calculated between a target output that is actually wanted in a final decision layer and an estimated output generated by a current network, and thus a corresponding value may be minimized. As an example, a loss function may be Formula 7 to Formula 9 but is not limited thereto.

Herein, it is possible to consider a case in which a d-dimensional target output and an estimated output are defined as t=[tl, . . . , td] and x=[xl, . . . , xd] respectively. Here, Formula 7 to Formula 9 may be a loss function for optimization.

$$Sum of Euclidean loss : {\sum }_{i = 1}^{d} {( {t}_{i} - {x}_{i} )}^{2} \qquad [ Formula 7 ]$$

$$Softmax loss : - {\sum }_{i = 1}^{d} {t}_{i} log \frac{{e}^{{x}_{j}}}{{\sum }_{j = 1}^{d} {e}^{{x}_{j}}} + ( 1 - {t}_{i} ) log ( 1 - \frac{{e}^{{x}_{j}}}{{\sum }_{j = 1}^{d} {e}^{{x}_{j}}} ) \qquad [ Formula 8 ]$$

$$Cross ‐ entropy loss : - {\sum }_{i = 1}^{d} {t}_{i} log {x}_{i} + ( 1 - {t}_{i} ) log ( 1 - {x}_{i} ) \qquad [ Formula 9 ]$$

In case the above-described loss function is given, gradients may be obtained for parameters, and then the parameters may be updated using the values.

As an example, a backpropagation algorithm may be an algorithm that simply calculates a gradient by using a chain rule. Based on the above-described algorithm, parallelization may also be easy to calculate a gradient of each parameter. In addition, a memory may also be saved through an algorithm design. Accordingly, a backpropagation algorithm may be used for updating a neural network. In addition, an example, a gradient for a current parameter needs to be calculated to use the gradient descent method. Herein, when a network becomes complex, a corresponding value may be complicated to calculate. On the other hand, in a backpropagation algorithm, a loss is first calculated by using a current parameter, and how much the loss is affected by each parameter may be calculated through a chain rule. An update may be performed based on a calculated value. As an example, a backpropagation algorithm may be divided into two phases. The one may be a propagation phase, and the other may be a weight update phase. Herein, in the propagation phase, an error or a change amount of each neuron may be calculated from a training input pattern. In addition, as an example, in the weight update phase, a weight may be updated by using the calculated value. As an example, the specific phases may be described as in Table 6 below.

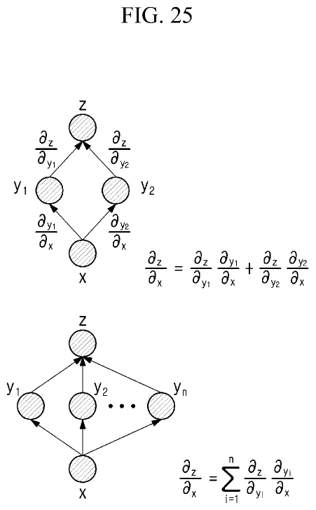

```
TABLE 6
- Phase 1: Propagation
  Forward propagation: calculates an output from input training data and
calculates an error at each output neuron. Here, since information flows in the
direction of input −> hidden −> output, it is called ‘forward’ propagation.
  Back propagation: calculates, by using a weight of each edge, how much an
error calculated at an output neuron is affected by neuron of a previous layer. Here,
since information flows in the direction of output −> hidden, it is called ‘back’
propagation.
- Phase 2: Weight update
  Gradients of parameters are calculated by using a chain rule. Here, as
shown in FIG. 25, the usage of a chain rule means that a current gradient is updated
by using a previously-calculated gradient.
```

As an example, FIG. 25 is a view showing a method of calculating a gradient by using a chain rule applicable to the present disclosure. Referring to FIG. 25, a method of obtaining ∂z/∂x may be disclosed. Herein, instead of calculating the value, a desired value may be calculated by using ∂z/∂y, which is a derivative already calculated in a y-layer, and ∂y/∂x that is related only to the y-layer and x. If there is a parameter x′ under x, ∂z/∂x′ may be calculated by using ∂z/∂x and ∂x′/∂x. Accordingly, a backpropagation algorithm may require only a derivative of an immediately previous variable of a parameter to be currently updated and a differential value of an immediately previous variable with respect to a current parameter.

The above-described process may be repeated downwards sequentially from an output layer. That is, a weight may keep updated in the process of “output->hidden k, hidden k->hidden k−1, . . . hidden 2->hidden 1, hidden 1->input”. After a gradient is calculated, only a parameter may be updated by using the gradient descent method itself

However, since a neural network has an enormous number of datasets, all the gradients needs to be calculated for all the training data in order to calculate an accurate gradient. Herein, after an accurate gradient is obtained by calculating an average of the values, the update may be performed ‘once’. However, as the above-described method is inefficient, the stochastic gradient descent (SDG) method may be used. Herein, instead of performing a gradient update by calculating an average of gradients of all the data (which referred to as full batch), the SGD may update all the parameters by forming a ‘mini batch’ from a part of the data and calculating a gradient only for a single batch. In case of convex optimization, when a specific condition is satisfied, it may be demonstrated that SGD and GD converge to a same global optimum, but since a neural network is not convex, a convergence condition may change according to a method of configuring a batch.

Complex Valued Neural Networks

A neural network processing complex numbers may have many advantages including neural network description and parameter representation. However, in comparison with using a real neural network processing real numbers, there may be some points to be considered for using a complex value neural network. As an example, when updating a weight through backpropagation, it is necessary to consider a constraint on an activate function. As an example, in the case of the sigmoid function

$$f ( t ) = \frac{1}{1 + {e}^{- t}}$$

of Formula 3, when t is a complex number, if t=e^{j(2n+1)π} (n is an integer), f(t) is 0 and cannot be differentiated. Accordingly, an activate function, which is generally used in a real neural network, is not applicable to a complex value neural network without constraints. Furthermore, according to Liouville's theorem, if a function is differentiable and bounded in the complex domain, it may be merely a constant function, and the Liouville's theorem may be described as in Table 7 below.

TABLE 7
Liouville's theorem: every bounded entire function must be constant. That is,
every holomorphic function f for which there exists a positive number M such that
for all z in C is constant Proof) If f is an entire function, it can be represented by
Taylor series about 0: where and Cr is circle about 0 of radius r>0. Suppose f is
bounded: i.e. there exists a constant M such that for all z.

As an example, based on Table 7, Formula 10 below may be derived by the Liouville's theorem.

$$\vert {a}_{k} \vert \leq \frac{1}{2 π} {∮}_{{C}_{r}} \frac{\vert f ( ζ ) \vert}{{\vert ζ \vert}^{k + 1}} \vert d ζ \vert \leq \frac{1}{2 π} {∮}_{{C}_{r}} \frac{M}{{r}^{k + 1}} \vert d ζ \vert = \frac{M}{2 π {r}^{k + 1}} {∮}_{{C}_{r}} \vert d ζ \vert = \frac{M}{2 π {r}^{k + 1}} 2 π r = \frac{M}{{r}^{k}} \qquad [ Formula 10 ]$$

Here, if r approaches infinite, then ak=0 for k≥1. Accordingly, f(z)=a0. However, it may be meaningless to use a constant function as an activate function of a neural network. Accordingly, the properties described in Table 8 may be necessary for a complex activation function f(z) which is made possible by backpropagation.

TABLE 8
Complex activation function, f(z) = u(x,y)+jv(x,y), properties for
backpropagation
f(z) is non-linear in x and y
f(z) is bounded
The partial derivatives, ux, uy, vx and vy exist and are bounded f(z) is
not entire

In case the properties described in Table 8 are satisfied, a complex activation function may have a form represented by Formula 11 below.

ƒ_{C→C}(z)=ƒ_{R}(Re(z))+jƒ_{I}(Im(z)) [Formula 11]

Here, an activate function like “sigmoid function” and “hyperbolic tangent function” used in a real neural network may be used for fR and fI.

Types of Neural Networks

Convolution Neural Network (CNN)

CNN may be a type of neural networks that are normally used for voice recognition or image recognition but not limited thereto. As CNN is configured to process multi-dimensional array data, it is specified in processing a multi-dimensional array like a color image. Accordingly, techniques using deep learning for image recognition may be mostly implemented based on CNN. As an example, a normal neural network processes image data as it is. That is, since an entire image is input as a single piece of data, the feature of the image is hard to find and the desired performance may not be achieved when the image changes its position only a little or becomes distorted as described above.

On the other hand, CNN can process an image not as a single piece of data but by dividing it into multiple pieces. Based on what is described above, CNN can extract a partial feature of an image, even when the image is distorted, and thus desired performance can be achieved. CNN may be defined by the following terms in Table 9.

TABLE 9
□ Convolution :
The convolution operation means the integral of the product between two functions
f and g, where one of the functions is reversed and shifted. In the discrete domain,
summation is used in place of integration.
□ Channel :
This means the number of data arrays constituting an input or output, when
convolution is performed.
□ Filter/kernel :
This means a function of convolution for input data and is also called kernel.
□ Dilation:
This means the spacing between data, when convolution with data is performed.
In case of dilation = 2, each dilation is extracted every two pieces of data to perform
convolution with kernel.
□ Stride :
This means the interval of shifting a filter/kernel during convolution.
□ Padding :
This means an operation of attaching a specific value (usually 0) to input data
during convolution.
□ Feature map:
This means the output of convolution.

Recurrent Neural Network (RNN)

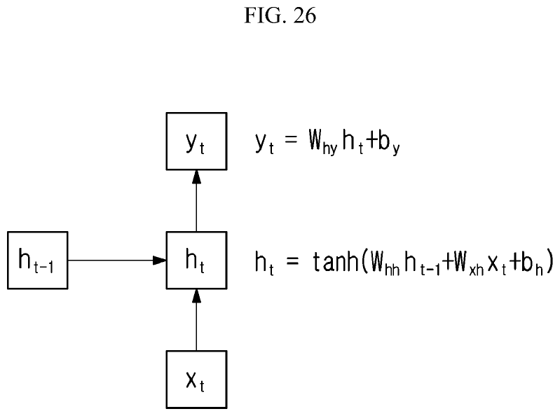

FIG. 26 is a view showing a learning model based on a RNN applicable to the present disclosure. Referring to FIG. 26, RNN may be a type of directed cycle artificial neural networks with hidden nodes connected with directional edges. As an example, RNN may be a suitable model for processing sequential data like voices and characters. One of the advantages of RNN is that various and flexible structures can be made as necessary since RNN has a network structure capable of accepting inputs and outputs irrespective of the length of sequences. As an example, in FIG. 26, ht (t=1, 2, . . . ) may represent a hidden layer, and x and y may represent an input and an output respectively. In case relevant information is distant from a point that uses the information, the gradient is gradually reduced during backpropagation so that RNN may have degraded learning performance, which is called the problem of “vanishing gradient”. As an example, the long-short term memory (LSTM) and the gated recurrent unit (GRU) may be structures that have been proposed to solve the “vanishing gradient” problem. That is, as compared with CNN, RNN may be a structure with feedback.

Autoencoder

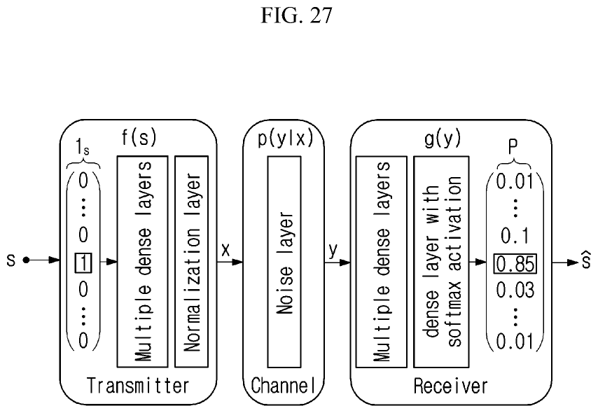

FIG. 27 is a view showing an autoencoder applicable to the present disclosure. Referring to FIG. 27, various attempts are being made to apply a neural network to a communication system. Herein, as an example, an attempt to apply a neural network to a physical layer focuses mainly on optimizing a specific function of a receiver. As a concrete example, in case a channel decoder is configured as a neural network, the performance of the channel decoder may be improved. As another example, in a MIMO system with a plurality of transmission/reception antennas, when a MIMO detector is configured as a neural network, the performance of the MIMO system may be improved.

As another example, an autoencoder method may be applied. Herein, the autoencoder may be configured as shown in FIG. 27 and improve the performance by configuring both the transmitter and the receiver as a neural network and performing optimization from the end-to-end perspective.

Hereinafter, specific embodiments of the present disclosure will be described based on what is described above. As described above, a communication system may operate by considering AI and machine learning based on a deep learning technology. Specifically, channel coding may be performed based on machine learning. As an example, in the 5G communication system, the channel coding schemes of low density parity check (LDPC) codes and polar codes have been introduced as new channel coding schemes, which are different from those of an existing communication system. Herein, the existing communication system performs channel coding through the Turbo code or tail-biting convolutional code (TBCC), and the LDCP coding and the polar coding may have better performance than the above-described coding schemes. However, in case the above-described coding methods are reflected in development and standards, the coding methods may be designed by being optimized for an additive white gaussian noise (AWGN) channel. As an example, in case a coding technique used for communication is not optimized for a channel, there may be a high probability that a transmission error occurs. In order to correct this, a communication system may have to perform retransmission (e.g., HARQ, ARQ).

Herein, when a base station performs retransmission, the base station may have to store data to be retransmitted for retransmission. In addition, a terminal, which receives data from the base station, may have to store previously-received data in order to combine the previously-received data and the retransmitted data. To this end, the terminal and the base station may have to have a memory.

In addition, as an example, when retransmission of data with error is performed, the throughput of a communication system may decrease. In addition, when data retransmission is performed, a resource may be wasted based on retransmission. In consideration of what is described above, by performing communication based on an encoder/decoder suitable for a link environment, a communication system may decrease a probability of occurrence of transmission error and reduce a retransmission ratio and a turn-around delay.

In consideration of what is described above, hereinafter will be described a method of performing communication by a device operating based on an autoencoder (AE) architecture in consideration of a channel environment. Herein, as described above, when operating based on an autoencoder, Tx and Rx may each include a neural network. At this time, Tx and Rx may learn an optimal communication environment including a channel environment and a coding technique. An autoencoder may perform encoding and decoding by using information obtained through learning. Specifically, both Tx and Rx may include a neural network, and encoding and decoding may be considered together as a pair so that data can be transmitted through coding thus performed.

Herein, as an example, devices with autoencoder (AE) architecture may be a terminal and a base station respectively. That is, a channel environment may be considered in communication between a terminal with an autoencoder architecture and a base station with an autoencoder. In addition, as an example, a channel environment may be considered in communication between a terminal with an autoencoder architecture and a terminal with an autoencoder.

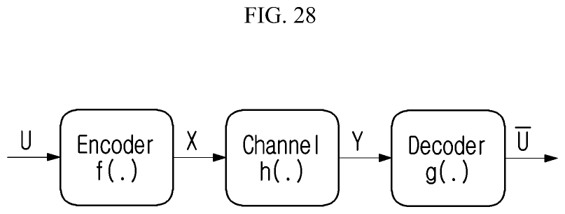

As an example, FIG. 28 is a view showing a communication chain using an autoencoder that is applicable to the present disclosure. Referring to FIG. 28, data may be encoded based on an autoencoder and be delivered from Tx to Rx. Then, the encoded data may be decoded based on an autoencoder at Rx. Herein, data may be encoded by an autoencoder in consideration of a channel environment, which is the same as described above.

As an example, an autoencoder may operate based on at least one of “Under-complete AE” and “Over-complete AE” architectures. Herein, referring to FIG. 28, data may be U, encoded data may be X, encoding data transmitted via a channel may be Y, and decoded data may be Ū. As an example, “Under-complete AE” may be a case in which X encoded based on an autoencoder is represented with a smaller amount than actual data U. Herein, the autoencoder may use a feature compression/extraction technique but is not limited thereto.

On the other hand, “Over-complete AE” may be a case in which the encoded X is represented with a larger amount than the actual data U. That is, it may be a method of adding redundancy to data. As an example, an autoencoder may be use a technique of adding parity like in channel coding but is not limited thereto.

Hereinafter, an autoencoder operating based on “Over-complete AE” will be described. As an example, in the case of an autoencoder operating based on “Over-complete AE”, a code-rate (R) may adjust a redundancy amount. That is, in FIG. 28 described above, the size of X may be (size of U)/R. In addition, the code rate R may be represented as in Formula 12.

R=k/n, [Formula 12]

Here, k may be |U|(=size of U), and n may be |X|(=size of X). That is, k may be a size of data, and n may be a size of encoded data. As an example, data U information may be encoded (over-complete) through an encoder in a reverse amount to a code rate R. In addition, a decoder may reconstruct the original data U information based on the same method.

As an example, when using an autoencoder, a communication system may form an optimized communication chain by considering a connection environment or situation. That is, a communication system may make an optimum communication chain through an autoencoder by considering a terminal (UE) capability or a channel characteristic. When an autoencoder operates based on the above description, a communication system may perform communication for a shorter time with less resources. As an example, in the case of massive data transmission (e.g., Tera-bps communication), Tx and Rx may reduce a retransmission probability by performing communication in an optimal communication environment even when an initial connection takes time. However, learning of the above-described autoencoder may not be easy.

In consideration of what is described above, hereinafter will be described a method of configuring a communication chain by an autoencoder and of synchronizing the communication chain between Tx and Rx. Tx and Rx described below may be a terminal and a base station respectively and be any one of the devices of FIG. 4 to FIG. 9. However, hereinafter, for convenience of explanation, the description is based on a case in which a terminal and a base station perform communication, but is not limited thereto. That is, it may be applied likewise to communication of a terminal, a base station, and any one of the devices of FIG. 4 to FIG. 9 and is not limited to the above-described embodiment.

Herein, as an example, when operating based on the above-described autoencoder, data communication using the autoencoder may have each neural network based on channels of Tx and Rx respectively, and learning may be performed by exchanging a large amount of data. As a concrete example, Tx may transmit, to Rx, a signal known to each other (e.g., reference signal). Herein, Rx may perform learning for a signal based on the known signal through a neural network and update information. Then, Rx may deliver updated information to Tx through backpropagation. Next, Tx may also perform learning based on the obtained information through a neural network. Tx and Rx may perform learning by repeating the above-described process and, after finishing learning by selecting optimal coding, perform data communication.

However, as described above, when each of Tx and Rx includes a neural network and performs learning by exchanging a massive amount of data, time and resources (bandwidth) may be wasted. In consideration of what is described above, hereinafter, an autoencoder may be implemented through any one of Tx and Rx, and thus the waste of time and resources may be prevented, of which a concrete method will be described below.

In addition, as an example, a new communication system may have various devices with heterogeneous communication protocols. Herein, efficient communication may be needed between different types of devices. In particular, Rx may be various forms of devices. As an example, Rx may be a low-power sensing device for Internet-of-Things (IoT). As another example, Rx may be a device considering high data reception. Herein, as described above, it may be inefficient or impossible for Tx and Rx to transmit and receive data in a uniform method in an environment with various forms of devices.

In consideration of what is described above, a communication system may implement encoding and decoding by using an autoencoder and considering a purpose of two communication subjects (e.g., Tx and Rx). As an example, the purpose of a communication subject may consider any one of low latency, high throughput, ultra-reliability, massive connection, and power consumption. As an example, for a service. communication subjects may perform communication for the purpose of latency equal to or lower than a reference value.

As another example, for massive data transmission, communication subjects may consider transmitting a throughput equal to or greater than a reference value. As another example, communication subjects may consider high stability. As another example, communication subjects may consider many connections in an environment where a plurality of nodes exist. As another example, communication subjects may consider low power by considering power of a sensor node. However, what is described above is only one example, and the present disclosure is not limited thereto. That is, communication subjects in a new communication system may perform communication based on various purposes. In addition, communication subjects may have various capabilities depending on communication purposes and are not limited to the above-described embodiment.

Considering the above-described situation, as communication subjects (Tx and Rx) may have different communication purposes and different device capabilities, they may not perform encoding and decoding in a uniform method. Accordingly, a communication system needs to construct an optimal network by considering the capability of a device. To this end, as described above, encoding and decoding may be implemented based on an autoencoder by considering information on each device capability.

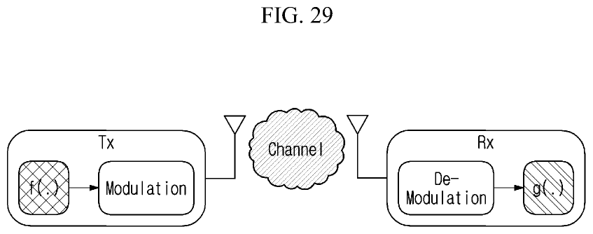

As a concrete example, FIG. 29 is a view showing a communication chain using a neural network that is applicable to the present disclosure. Referring to FIG. 29, f(·) of Tx and g(·) of Rx may mean channel coding that is learned (or converged) by being optimized to an ideal channel (e.g., AWGN channel). Herein, a modulator and a demodulator may generate a log likelihood ratio (LLR) for channel coding by performing precoding/equalization in consideration of a case of a channel environment varying with time. Herein, the generated LLR may be used as an input of g(·). That is, encoded data transmitted by Tx may be delivered as an LLR value to Rx through a channel. Herein, in case f(·) and g(·) are learned, an autoencoder may perform learning, as described above, by reflecting various communication purposes and the capability of each of Tx and Rx devices. That is, a device-oriented autoencoder (AE) may be implemented, and the AE may perform encoding and decoding.

Herein, as an example, as described above, a Tx device and a Rx device may have different capabilities. Herein, when Tx and Rx perform communication based on an AE, the Tx and the Rx need to recognize capability information of each other in advance. As an example, the above-described capability information may be device AI capability, as shown in Table 10.

More specifically, when no neural network is implemented in a device so that the device cannot perform AI-based learning but operates based on an existing coding scheme (e.g., LDPC/polar coding), the device may be a type 1 or level 1 device. However, this is only one example and may not be limited to the above-described name but be called by another name.

In addition, when a flexible neural network is constructed in a device but there is no computing process for training, the device may be a type 2 or level 2 device. That is, a device may have a layer node and operate based on a weight but may not be capable of performing learning. As an example, when no GPU or CPU for learning is implemented in a device, the device cannot perform learning, and it may be a type 2 or level 2 device. However, this is only one example and may not be limited to the above-described name but be called by another name.

In addition, when a flexible neural network is constructed in a device and there is a computing process for training, the device may be a type 3 or level 3 device. That is, a device may have a layer node, operate based on a weight, and also be capable of performing learning. As an example, when a GPU or CPU for learning is implemented in a device and the device performs learning based on it, the device may be a type 3 or level 3 device. However, this is only one example and may not be limited to the above-described name but be called by another name.

Herein, as an example, information for indicating capability information of Table 10 below may be configured with 2 bits. As a more concrete example, it is possible to consider a case in which a base station and a terminal perform communication. Herein, as an example the base station may be the above-described level 3 device. That is, the base station may configure a flexible neural network and operate based on an autoencoder with learning capability. On the other hand, the terminal may be any one of the above-described level 1 device, level 2 device and level 3 device. In the above-described case, the terminal may perform connection in order to perform communication with the base station. At this time, during a process of performing the connection, the terminal may transmit information on Table 10 below as terminal capability information to the base station. As an example, the above-described connection may be a RRC connection. When a terminal exchanges a message for RRC connection, the terminal may deliver capability information like Table 10 below through a field indicating capability information in the message. In addition, as an example, since a base station may be configured as an item with high power and operation process, level 3 may be set to a default value, and no separate signaling may be needed. As another example, a base station may have a different capability based on Table 10 below, and relevant information may be signaled to a terminal, but the present disclosure is not limited to the above-described embodiment.

As another example, in case of communication between terminals (e.g., V2X), a Tx terminal and a Rx terminal may exchange information on Table 10 below before performing direct communication. As an example, when performing PC5 RRC connection, a Tx terminal and a Rx terminal may exchange information on Table 10 below and thus identify capability information between them. As another example, when terminals perform direct communication by controlling a base station based on a base station scheduling mode, a base station may control to perform the communication by delivering information on Table 10 below for a Tx terminal and a Rx terminal to the Tx terminal and the Rx terminal respectively, but is not limited to the above-described embodiment.

That is, capability information like Table 10 below may be set in Tx and Rx, and capability information of each device may be exchanged before communication is performed, but the present disclosure is not limited to the above-described embodiment.

In addition, as an example, device capability information may have another capability apart from the capabilities indicated by Table 10 below and not be limited to the embodiment of Table 10 below.

TABLE 10

* Level-1 Device(C=0)
- Device cannot execute AI.
- Conventional coding scheme cannot be supported.
* Level-2 Device (C=1)
- Device can configure a flexible NN.
- There is no computing process for training.
* Level-3 Device (C=2)
- Device can configure a flexible NN.
- Device has a computing process for training.

In consideration of what is described above, hereinafter will be described a method of configuring “On Device AE.” That is, an optimized encoder/decoder technique for channel coding may be generated by performing learning at any one of Tx and Rx. As an example, Tx and Rx may measure a channel and generate an encoder/decoder technique optimized for the measured channel through an AI in a device. That is, a device may perform learning through an AI in the device and configure an encoder f(·) and a decoder (g⋅), and a specific method for it will be described below.

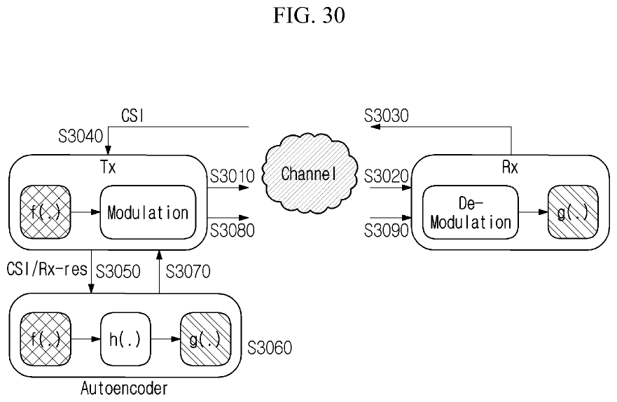

FIG. 30 is a view showing a method of configuring an autoencoder at Tx that is applicable to the present disclosure.

Referring to FIG. 30, Tx may transmit a reference signal (RS) for estimating a channel between Tx and Rx (Tx-Rx channel) to Rx (S3010). Herein, Tx may have an autoencoder based on a neural network. Next, Rx may receive the reference signal from Tx (S3020) and estimate channel state information (CSI) by using the reference signal. Next, Rx may transmit the CSI to Tx (S3030). Herein, Tx may receive the CSI transmitted from Rx (S3040). In addition, as an example, Tx may obtain information on a resource of Rx (Rx-resource information) from Rx. As an example, Rx-resource information may include capability information of Rx. As an example, Rx-resource information may include at least any one or more of network type information, weights information, number of layers information, and activation function information of Rx. Herein, as an example, Rx may be a device with a neural network based on the level 2 device of Table 10 described above, having no learning capability though. That is, as Rx has a flexible neural network, network information (e.g., CNN and RNN) as information on a neural network used at Rx may be included in resource information of Rx and be delivered to Tx. In addition, the resource information of Rx may further include, based on a neural network operation, at least any one of weights information, number of layers information, and activation function information, but is not limited to the above-described embodiment. In addition, the resource information of Rx may further other information associated with Rx capability and is not limited to the above-described embodiment.

As another example, in case Rx operates based on the level 1 device in Table 10 described above, since Rx includes no neural network, only the Rx capability information of Table 10 may be delivered to Tx. Herein, as an example, Tx may transmit data through a coding scheme (e.g., LDCP/polar) of a conventional communication system based on Rx capability information and CSI. That is, although Tx has an autoencoder, it may apply a conventional coding scheme by considering capability of Rx, which will be described below.

In addition, as an example, the above-described resource information of Rx may be delivered through RRC in Tx-Rx pairing. In addition, as an example, Tx and Rx may exchange the above-described Rx resource information in another method and are not limited to the above-described embodiment.

Next, Tx may deliver, to an autoencoder, at least any one of CSI and resource capability information of Rx (Rx-res information) that are received from Rx. Herein, as an example, an autoencoder may be implemented within Tx. As another example, an autoencoder and Tx may be connected via a network, and Tx may operate in a way of delivering the above-described information to the autoencoder but is not limited to the above-described embodiment. In addition, as an example, Tx may deliver not only information on Rx but also capability information of Tx to the autoencoder (S3050).

Next, the autoencoder may reconfigure a g(·) function considering a neural network of Rx by using CSI and Rx resource information (S3060). More specifically, the autoencoder may learn (or converge) optimal f(·) and g(·) suitable for a channel h(·) based on CSI. Next, the autoencoder may deliver information on f(·) and g(·), which are derived through learning, to Tx (S3070). Herein, f(·) may be used for data encoding of Tx. In addition, g(·) may be used for data decoding of Rx. Next, Tx may deliver information obtained from the autoencoder to Rx. That is, Rx may obtain g(·)-related information for decoding from Tx. As an example, g(·)-related information may include any one of value information of g(·), weights information, number of layers information, and activation function information, but is not limited to the above-described embodiment. In addition, as an example, Tx may further deliver f(·)-related information to Rx, but this is not necessary however.

Next, a modulator of Tx may perform operations of rate matching, waveform, framing, and analog front. That is, Tx may transmit data, which is encoded based on f(·), to Rx through the channel h(·) after a modulation process (S3080). Next, Rx may receive a signal transmitted by Tx (S3090). At this time, a demodulator of Rx may perform, for the received signal, functions of an analog digital converter (ADC), a radio frequency (RF) front operation like automatic gain control (AGC), synchronization and equalization. That is, Rx may generate LLR for input of g(·) through demodulation of the received signal. Then, Rx may perform decoding based on g(·) and reconstruct data.

Herein, as an example, the autoencoder may train f and g by reflecting CSI(h), as described above. Herein, the autoencoder may consider a case in which channel state information h is assumed as an ideal channel. Herein, since the channel may be ideal, Tx may not perform an operation of transmitting the reference signal. An autoencoder of Tx may learn f(·) optimized for g(·) based on information obtained from Rx, as described above.

Meanwhile, as an example, in the above-described case, Tx may be at least any one of a base station, a terminal, and a device of FIG. 4 to FIG. 9. In addition, as an example, Rx may be any one of a base station, a terminal, and a device of FIG. 4 to FIG. 9. That is, for convenience of explanation, they are described as Tx and Rx in the above description, and Tx and Rx may not be limited to a particular device.

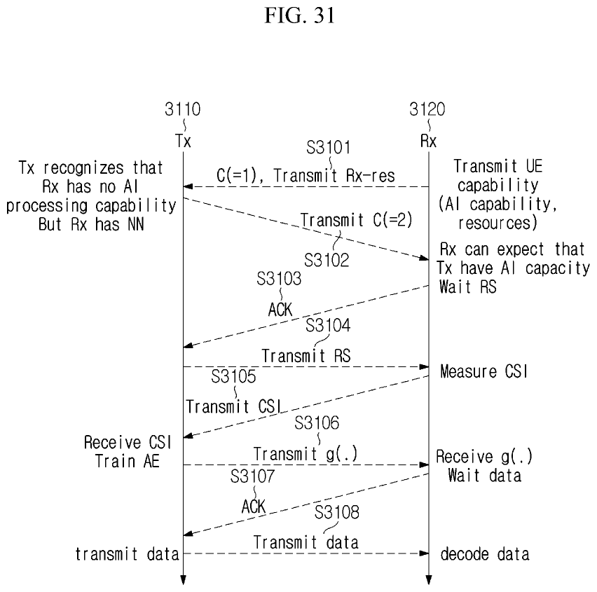

FIG. 31 is a view showing a method of performing data transmission based on an autoencoder at Tx that is applicable to the present disclosure.

Referring to FIG. 31, as described above, Tx 3110 and Rx 3120 may perform learning for configuring optimal channel coding. Herein, as an example, Tx 3110 may be a device that has a flexible neural network and is capable of performing learning based on an autoencoder. In addition, as an example, Rx 3120 may be a device that has a flexible neural network but is not capable of performing learning. That is, learning for optimal channel coding may be performed at Tx 3110.

More specifically, Tx 3110 and Rx 3120 may be paired or connected with each other. As an example, Tx 3110 and Rx 3120 may perform RRC connection. Herein, Rx 3120 may transmit capability information of Rx to Tx 3110 (S3101). As an example, Rx 3120 may transmit capability information of Rx based on Table 10 described above to Tx 3110. In addition, as an example, Rx 3120 may deliver resource information of Rx to Tx 3110, and this may be the same as in FIG. 30.

Herein, as a concrete example, Tx 3110 may recognize, based on information received from Rx 3120, that Rx 3120 is a device which configures a neural network but has no learning capability. Herein, as Tx 3110 may configure a flexible neural network and perform learning, Tx 3110 may deliver information on it to Rx 3120. That is, Tx 3110 may also deliver capability information of Tx to Rx 3120 (S3102). Herein, Rx 3120 may recognize, based on information received from Tx 3110, that Tx 3110 performs learning. Next, Rx 3120 may transmit an ACK message to Tx 3110 and stand by to receive a reference signal (S3103).

Next, Tx 3110 may transmit a reference signal to Rx 3120 (S3104). Herein, Rx 3120 may measure CSI based on the received reference signal and transmit the measured CSI to Tx 3110 (S3105). Herein, as an example, in case Tx 3110 assumes that a channel is ideal, the above-described operations of S3104 and S3105 may be omitted but are not limited thereto.

Next, Tx 3110 may perform learning based on any one of the received CSI and capability information (or resource information) of Rx. That is, Tx 3110 may perform learning by delivering the above-described information to an autoencoder. Next, Tx 3110 may obtain, based on learning, g(·) information for decoding of Rx from the autoencoder and transmit information on it to Tx 3120 (S3106). Rx 3120 may obtain information on g(·) and transmit ACK to Tx 3110 (S3107). Next, Tx 3110 may transmit data, which is encoded through f(·) based on learned information, to Rx 3120 (S3108). Next, Rx 3120 may perform decoding for a signal received through delivered g(·) and reconstruct data.

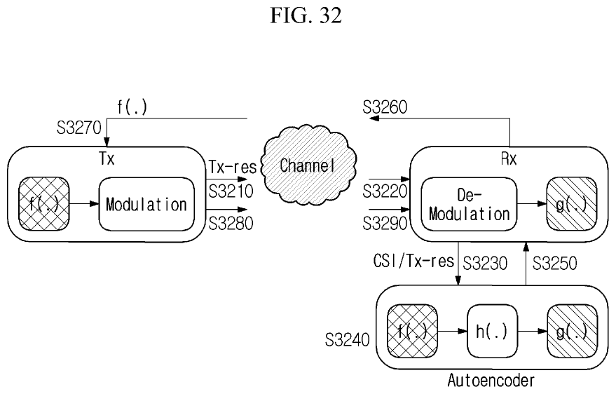

FIG. 32 is a view showing a method of configuring an autoencoder at Rx that is applicable to the present disclosure.

Referring to FIG. 32, Tx may transmit a reference signal (RS) for estimating a channel between Tx and Rx (Tx-Rx channel) to Rx. Herein, Tx may transmit resource information of Tx with the reference signal to Rx (S3210). Herein, as an example, the resource information of Tx may include capability information of Tx. As an example, resource information of Tx may include at least any one or more of network type information, weights information, number of layers information, and activation function information of Tx. Herein, as an example, Tx may be a device with a neural network based on the level 2 device of Table 10 described above, having no learning capability though. That is, as Tx has a flexible neural network, network information (e.g., CNN and RNN) as information on a neural network used at Tx may be included in resource information of Tx and be delivered to Rx. In addition, the resource information of Tx may further include, based on a neural network operation, at least any one of weights information, number of layers information, and activation function information, but is not limited to the above-described embodiment. In addition, the resource information of Tx may further other information associated with Tx capability and is not limited to the above-described embodiment.

As another example, when Tx operates based on a level 1 device in Table 10 described above, since Tx does not include any neural network, it may deliver only Tx capability information of Table 10 to Rx. Herein, as an example, Rx may expect to receive data through a coding scheme (e.g., LDCP/polar) of a conventional communication system based on Tx capability information and CSI. That is, although Rx has an autoencoder, it may apply a conventional coding scheme by considering capability of Rx, which will be described below.

Meanwhile, as an example, it is possible to consider a case in which Rx is a device with an autoencoder based on a neural network and with learning capability and Tx is a device with a neural network but without learning capability. Herein, Rx may receive a reference signal and resource information of Tx from Tx (S3220). Meanwhile, as an example, the above-described resource information of Tx may be delivered through RRC in Tx-Rx pairing. That is, Tx may deliver resource information of Tx to Rx in advance and, when performing channel estimation, transmit only a reference signal. As another example, Tx and Rx may exchange the above-described Rx resource information in another method and are not limited to the above-described embodiment.

Herein, Rx may estimate channel state information (CSI) by using a reference signal. Next, Rx may deliver CSI and resource information of Tx to an autoencoder (S3230).

Herein, as an example, the autoencoder may be implemented within Rx. As another example, an autoencoder and Rx may be connected via a network, and Rx may operate in a way of delivering the above-described information to the autoencoder but is not limited to the above-described embodiment. In addition, as an example, Rx may deliver not only information on Tx but also capability information of Rx to the autoencoder.

Next, the autoencoder may reconfigure a g(·) function considering a neural network of Tx by using CSI and Tx resource information (S3240). More specifically, the autoencoder may learn (or converge) optimal f(·) and g(·) suitable for a channel h(·) based on CSI. Next, the autoencoder may deliver information on f(·) and g(·), which are derived through learning, to Rx (S3250). Herein, f(·) may be used for data encoding of Tx. In addition, g(·) may be used for data decoding of Rx. Next, Rx may deliver information obtained from the autoencoder to Tx (S3260). That is, Tx may obtain f(·)-related information for encoding from Rx (S3270). As an example, f(·)-related information may include any one of value information of f(·), weights information, number of layers information, and activation function information, but is not limited to the above-described embodiment. In addition, as an example, Rx may further deliver f(·)-related information to Tx, but this is not necessary, however.

Next, a modulator of Tx may perform operations of rate matching, waveform, framing, and analog front. That is, Tx may transmit data, which is encoded based on f(·), to Rx through the channel h(·) after a modulation process (S3280). Next, Rx may receive a signal transmitted by Tx (S3290). At this time, a demodulator of Rx may perform, for the received signal, functions of an analog digital converter (ADC), a radio frequency (RF) front operation like automatic gain control (AGC), synchronization and equalization. That is, Rx may generate LLR for input of g(·) through demodulation of the received signal. Then, Rx may perform decoding based on g(·) and reconstruct data.

Herein, as an example, the autoencoder may train f and g by reflecting CSI(h), as described above. Herein, the autoencoder may consider a case in which channel state information h is assumed as an ideal channel. Herein, since the channel may be ideal, Tx may not perform an operation of transmitting the reference signal. An autoencoder of Rx may learn g(·) optimized for f(·) based on information obtained from Tx, as described above.

Meanwhile, as an example, in the above-described case, Tx may be at least any one of a base station, a terminal, and a device of FIG. 4 to FIG. 9. In addition, as an example, Rx may be any one of a base station, a terminal, and a device of FIG. 4 to FIG. 9. That is, for convenience of explanation, they are described as Tx and Rx in the above description, and Tx and Rx may not be limited to a particular device.

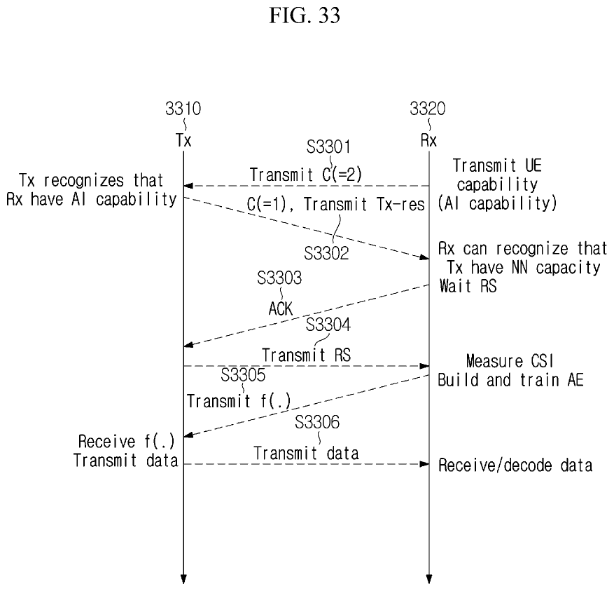

FIG. 33 is a view showing a method of performing data transmission based on an autoencoder at Rx that is applicable to the present disclosure.

Referring to FIG. 33, as described above, Tx 3310 and Rx 3320 may perform learning for configuring optimal channel coding. Herein, as an example, Rx 3320 may be a device that has a flexible neural network and is capable of performing learning based on an autoencoder. In addition, as an example, Tx 3310 may be a device that has a flexible neural network but is not capable of performing learning. That is, learning for optimal channel coding may be performed at Rx 3320.

More specifically, Tx 3310 and Rx 3320 may be paired or connected with each other. As an example, Tx 3310 and Rx 3320 may perform RRC connection. Herein, Rx 3320 may transmit capability information of Rx to Tx 3310 (S3301). As an example, Rx 3320 may transmit capability information of Rx based on Table 10 described above to Tx 3310. Herein, Rx 3320 may be a device that has a neural network and learning capability. In addition, as an example, Tx 3310 may deliver resource information of Tx to Rx 3320, and this may be the same as in FIG. 32.

Herein, as a concrete example, Tx 3310 may recognize, based on information received from Rx 3320, that Rx 3320 is a device which configures a neural network and has learning capability. Herein, Tx 3310 may configure a flexible neural network but not be capable of performing learning, and Tx 3310 may deliver information on it to Rx 3320. That is, Tx 3310 may deliver capability information of Tx to Rx 3320 (S3302). Herein, as an example, Tx 3310 may also deliver resource information of Tx to Rx 3320 (S3302). Herein, Rx 3320 may recognize, based on information received from Tx 3310, that Rx 3320 performs learning. Next, Rx 3320 may transmit an ACK message to Tx 3310 and stand by to receive a reference signal (S3303).

Next, Tx 3310 may transmit a reference signal to Rx 3320 (S3304). Herein, Rx 3220 may measure CSI based on the received reference signal and deliver the measured CSI and resource information of Tx to the autoencoder. Next, Rx 3320 may obtain information on f(·) from the autoencoder and transmit the information to Tx 3310 (S3305). Herein, as an example, in case Rx 3320 assumes that a channel is ideal, the above-described operations of S3304 and S3305 may be omitted but are not limited thereto.

Next, Tx 3310 may transmit data, which is encoded through f(·) based on learned information, to Rx 3320 (S3306). Next, Rx 3320 may perform decoding for a signal received through g(·) and reconstruct data.

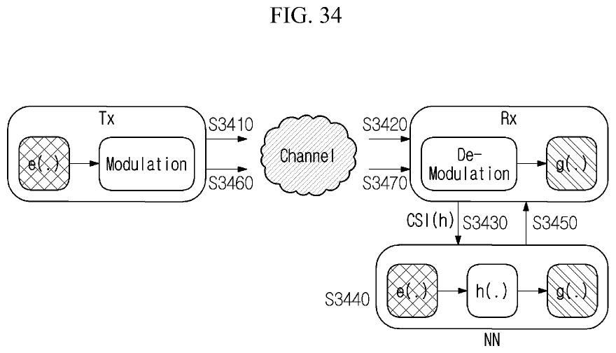

FIG. 34 is a view showing a method of configuring an autoencoder at Rx that is applicable to the present disclosure.

Referring to FIG. 34, Tx may transmit a reference signal (RS) for estimating a channel between Tx and Rx (Tx-Rx channel) to Rx (S3410). Herein, Tx may have a function of fixed data encoding e(·). That is, based on Table 10 described above, Tx may be a device that does not configure any neural network and uses a fixed data encoding scheme. As an example, Tx may use a conventional coding scheme (e.g., LDPC/polar/turbo) as a fixed data encoding scheme. On the other hand, Rx may be a device that configures a neural network and has learning capability. That is, it may correspond to the level 3 device in the above-described Table 10. In the above-described case, Rx may learn g(·) optimized for e(·) and h(·) based on Tx information. Specifically, as described above, Rx may receive a reference signal transmitted by Tx (S3420). Herein, Rx may estimate channel state information (CSI) by using a reference signal. Next, Rx may deliver CSI to an autoencoder (S3430). In addition, Rx may deliver, to the autoencoder, information indicating that Tx uses a fixed data encoding scheme. As an example, Tx may deliver capability information of Tx to Rx, when performing pairing or connection with Rx. As an example, Tx may transmit information on e(·) to Rx based on a fixed encoding scheme in a RRC connection process. Herein, as described above, Tx may estimate CSI based on the reference signal and deliver CSI and e(·) information to the autoencoder. Herein, as an example, the autoencoder may be implemented within Rx. As another example, an autoencoder and Rx may be connected via a network, and Rx may operate in a way of delivering the above-described information to the autoencoder but is not limited to the above-described embodiment. In addition, as an example, Rx may deliver not only information on Tx but also capability information of Rx to the autoencoder.

Next, the autoencoder may learn g(·) for decoding based on CSI h(·) and e(·) information (S3440). That is, the autoencoder may learn and derive g(·) for decoding based on channel information and fixed encoding information of Tx. Next, the autoencoder may deliver information on g(·), which is derived through learning, to Rx (S3450). As an example, g(·)-related information may include any one of value information of g(·), weights information, number of layers information, and activation function information, but is not limited to the above-described embodiment.

Next, a modulator of Tx may perform operations of rate matching, waveform, framing, and analog front. That is, after a modulation process for data to which a fixed encoding scheme is applied based on e(·), Tx may transmit the data to Rx through the channel h(·) (S3460). Next, Rx may receive a signal transmitted by Tx (S3470). At this time, a demodulator of Rx may perform, for the received signal, functions of an analog digital converter (ADC), a radio frequency (RF) front operation like automatic gain control (AGC), synchronization and equalization. That is, Rx may generate LLR for input of g(·) through demodulation of the received signal. Then, Rx may perform decoding based on g(·) and reconstruct data.

Herein, as an example, the autoencoder may train g by reflecting CSI(h), and this is the same as described above. Herein, the autoencoder may consider a case in which channel state information h is assumed as an ideal channel. Herein, since the channel may be ideal, Tx may not perform an operation of transmitting the reference signal. An autoencoder of Rx may learn g(·) optimized for e(·) based on information obtained from Tx, as described above.

Meanwhile, as an example, in the above-described case, Tx may be at least any one of a base station, a terminal, and a device of FIG. 4 to FIG. 9. In addition, as an example, Rx may be any one of a base station, a terminal, and a device of FIG. 4 to FIG. 9. That is, for convenience of explanation, they are described as Tx and Rx in the above description, and Tx and Rx may not be limited to a particular device.

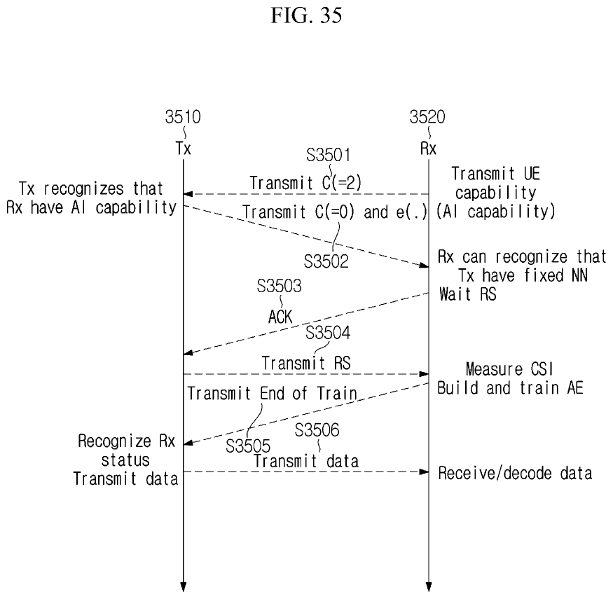

FIG. 35 is a view showing a method of performing data transmission based on an autoencoder at Rx that is applicable to the present disclosure.

Referring to FIG. 35, as described above, Tx 3510 and Rx 3520 may perform learning for configuring optimal channel coding. Herein, as an example, Rx 3520 may be a device that has a flexible neural network and is capable of performing learning based on an autoencoder. In addition, as an example, Tx 3510 may be a device that has no neural network and operates based on a fixed encoding scheme. That is, learning for optimal channel coding may be performed at Rx 3520.

More specifically, Tx 3510 and Rx 3520 may be paired or connected with each other. As an example, Tx 3510 and Rx 3520 may perform RRC connection. Herein, Rx 3520 may transmit capability information of Rx to Tx 3510 (S3501). As an example, Rx 3520 may transmit capability information of Rx based on Table 10 described above to Tx 3510. Herein, Rx 3520 may be a device that has a neural network and learning capability. In addition, as an example, Tx 3510 may transmit capability information of Tx to Rx. Herein, Tx 3510 may transmit, to Rx 3520, information indicating that Tx 3510 is a level 1 device based on Table 10 described above. In addition, as an example, Tx 3510 may transmit, to Rx 3520, information e(·) on a fixed encoding scheme and capability information of Tx (S3502).

Herein, as a concrete example, Tx 3510 may recognize, based on information received from Rx 3520, that Rx 3520 is a device which configures a neural network and has learning capability. Herein, Tx 3510 may configure a flexible neural network but not be capable of performing learning, and Tx 3510 may deliver information on it to Rx 3520. That is, Tx 3510 may transmit capability information of Tx to Rx 3520 (S3502). Herein, as an example, Tx 3510 may also deliver resource information of Tx to Rx 3520 (S3502). Herein, Rx 3520 may recognize, based on information received from Tx 3510, that Rx 3520 performs learning. Next, Rx 3520 may transmit an ACK message to Tx 3510 and stand by to receive a reference signal (S3503).

Next, Tx 3510 may transmit a reference signal to Rx 3520 (S3504). Herein, Rx 3520 may measure CSI based on the received reference signal and deliver the measured CSI and resource information of Tx to the autoencoder. Next, Rx 3520 may complete learning and obtain information on g(·). In addition, as an example, Rx 3520 may transmit, to Tx 3510, information indicating that learning is completed (S3505). As an example, Rx 3520 may transmit information indicating that learning is completed together with information on g(·), but is not limited to the above-described embodiment. In addition, as an example, in case Rx 3520 assumes that a channel is ideal, the above-described operation of S3504 may be omitted but is not limited thereto.

Next, Tx 3510 may transmit data, which is encoded through e(·) that is fixed scheme based on learned information, to Rx 3520 (S3506). Next, Rx 3520 may perform decoding for a signal received through g(·) and reconstruct data.

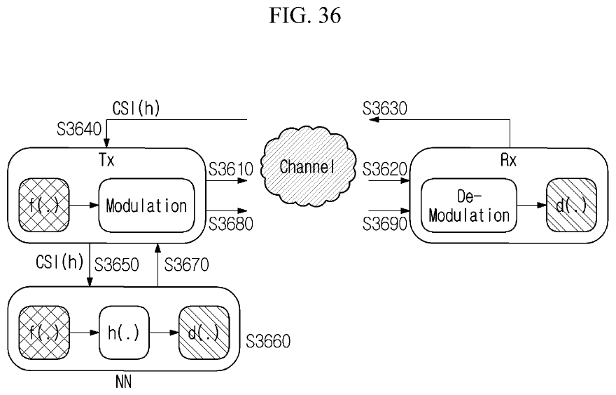

FIG. 36 is a view showing a method of configuring an autoencoder at Tx that is applicable to the present disclosure.

Referring to FIG. 36, Tx may transmit a reference signal (RS) for estimating a channel between Tx and Rx (Tx-Rx channel) to Rx (S3610). Herein, Tx may have an autoencoder based on a neural network. Next, Rx may receive the reference signal from Tx (S3620) and estimate channel state information (CSI) by using the reference signal. Next, Rx may transmit the CSI to Tx (S3630). Herein, Tx may receive the CSI transmitted by Rx (S3640). Herein, as an example, Rx may be a device that uses a fixed decoding scheme. That is, Rx may be a device that has no neural network and operates based on a conventional decoding scheme (LDPC/polar/turbo). That is, Rx may be the level 1 device in Table 10 described above. In addition, as an example, the above-described capability information of Rx and decoding scheme d(·) information may be delivered through RRC in Tx-Rx pairing. In addition, as an example, Tx and Rx may exchange the above-described Rx capability information and decoding scheme d(·) information in another method and are not limited to the above-described embodiment.

Next, Tx may deliver CSI received from Rx to an autoencoder (S3650). Herein, as an example, an autoencoder may be implemented within Tx. As another example, an autoencoder and Tx may be connected via a network, and Tx may operate in a way of delivering the above-described information to the autoencoder but is not limited to the above-described embodiment. In addition, as an example, Tx may deliver not only information on Rx but also capability information of Tx to the autoencoder.

Next, the autoencoder may reconfigure a f(·) function considering a neural network of Tx by using CSI and d(·) information (S3660). More specifically, the autoencoder may learn (or converge) optimal f(·) suitable for a channel h(·) and a fixed decoding scheme d(·) based on CSI. Next, the autoencoder may deliver information on f(·), which is derived through learning, to Tx (S3670). Herein, f(·) may be used for data encoding of Tx. In addition, d(·) may be used for data decoding of Rx.

Next, a modulator of Tx may perform operations of rate matching, waveform, framing, and analog front. That is, Tx may transmit data, which is encoded based on f(·), to Rx through the channel h(·) after a modulation process (S3680). Next, Rx may receive a signal transmitted by Tx (S3690). At this time, a demodulator of Rx may perform, for the received signal, functions of an analog digital converter (ADC), a radio frequency (RF) front operation like automatic gain control (AGC), synchronization and equalization. That is, Rx may generate LLR for input of d(·) through demodulation for the received signal. Then, Rx may perform decoding based on d(·) and reconstruct data.

Herein, as an example, the autoencoder may train f by reflecting CSI(h), and this is the same as described above. Herein, the autoencoder may consider a case in which channel state information h is assumed as an ideal channel. Herein, since the channel may be ideal, Tx may not perform an operation of transmitting the reference signal. An autoencoder of Tx may learn f(·) optimized for d(·) based on information obtained from Rx, as described above.

Meanwhile, as an example, in the above-described case, Tx may be at least any one of a base station, a terminal, and a device of FIG. 4 to FIG. 9. In addition, as an example, Rx may be any one of a base station, a terminal, and a device of FIG. 4 to FIG. 9. That is, for convenience of explanation, they are described as Tx and Rx in the above description, and Tx and Rx may not be limited to a particular device.

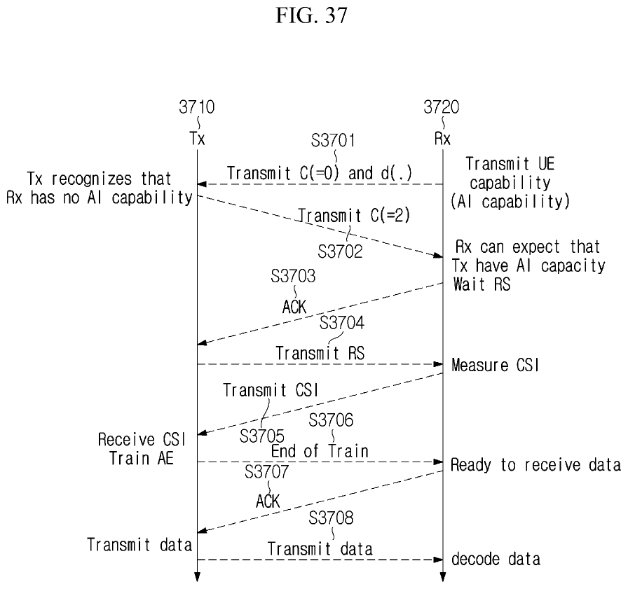

FIG. 37 is a view showing a method of performing data transmission based on an autoencoder at Tx that is applicable to the present disclosure.

Referring to FIG. 37, as described above, Tx 3710 and Rx 3720 may perform learning for configuring optimal channel coding. Herein, as an example, Tx 3710 may be a device that has a flexible neural network and is capable of performing learning based on an autoencoder. In addition, as an example, Rx 3720 may be a device that has no flexible neural network and uses a fixed decoding scheme. That is, learning for optimal channel coding may be performed at Tx 3710.

More specifically, Tx 3710 and Rx 3720 may be paired or connected with each other. As an example, Tx 3710 and Rx 3720 may perform RRC connection. Herein, Rx 3720 may transmit capability information of Rx to Tx 3710 (S3701). As an example, Rx 3720 may transmit capability information of Rx based on Table 10 described above to Tx 3710. In addition, as an example, Rx 3720 may deliver d(·) information, which is a fixed decoding scheme of Rx, to Tx 3710, and this may be the same as in FIG. 36.

Herein, as a concrete example, Tx 3710 may recognize that Rx 3720 is a device using a fixed decoding scheme (e.g., LDPC/polar/turbo), based on information received from Rx 3720, and check the decoding scheme d(·). Herein, as Tx 3710 may configure a flexible neural network and perform learning, Tx 3710 may information on it to Rx 3720. That is, Tx 3710 may also transmit capability information of Tx to Rx 3720 (S3702). Herein, Rx 3720 may recognize, based on information received from Tx 3710, that Tx 3710 performs learning. Next, Rx 3720 may transmit an ACK message to Tx 3710 and stand by to receive a reference signal (S3703).

Next, Tx 3710 may transmit a reference signal to Rx 3720 (S3704). Herein, Rx 3720 may measure CSI based on the received reference signal and transmit the measured CSI to Tx 3710 (S3705). Herein, as an example, in case Tx 3710 assumes that a channel is ideal, the above-described operations of S3704 and S3705 may be omitted but are not limited thereto.

Next, Tx 3710 may transmit, to Rx 3720, information indicating that learning is completed (S3706). Herein, as an example, Tx 3710 may also transmit f(·) information to Rx 3720 based on learning but is not limited to the above-described embodiment. Next, Rx 3720 may transmit ACK information to Tx 3710 and stand by to receive data (S3707). Next, Tx 3710 may transmit data, which is encoded through f(·) based on learned information, to Rx 3720 (S3708). Next, Rx 3720 may perform decoding for a signal, which is received through d(·) that is a fixed decoding scheme, and reconstruct data.

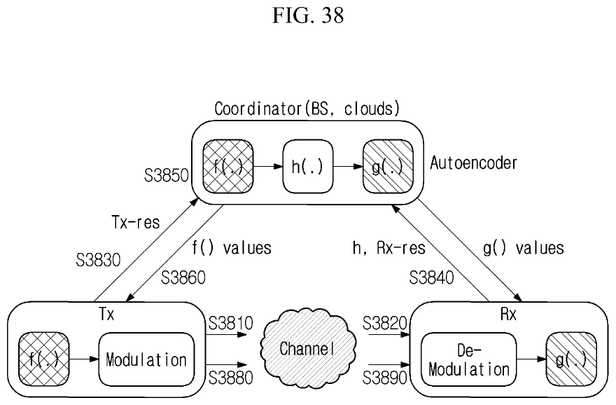

FIG. 38 is a view showing a method of configuring an autoencoder at a coordinator that is applicable to the present disclosure.

Referring to FIG. 38, Tx and Rx may be a device with a neural network but without learning capability. That is, both Tx and Rx may be a device corresponding to level 2 in the above-described Table 10.

Herein, as an example, an autoencoder for Tx and Rx may operate by being provided in a third device. As an example, a third device may be a coordinator device. As an example, a third device may be a device that has a neural network and learning capability. As an example, a third device may be at least any one of a base station and a cloud. In addition, as an example, a third device may be another device or any one of the devices of FIG. 4 to FIG. 9 but is not limited to the above-described embodiment. In addition, as an example, both Tx and Rx may be a terminal. As an example, Tx and Rx may be a vehicle to everything (V2X) terminal that perform direct connection. That is, a plurality of terminals may perform direct communication under the control of a base station but is not limited thereto. Hereinafter, for convenience of explanation, Tx, Rx, and a third device will be described, but the present disclosure is not limited thereto.

As an example, Tx may transmit a reference signal (RS) for estimating a channel between Tx and Rx (Tx-Rx channel) to Rx (S3810). Rx may receive the reference signal from Tx (S3820) and estimate channel state information (CSI) by using the reference signal. Next, Tx may also transmit resource information of Tx to a third device (S3830). Herein, as an example, Tx-resource information may include at least any one or more of network type information, weights information, number of layers information, and activation function information of Rx.

In addition, Rx may transmit CSI to the third device (S3840). In addition, Rx may estimate CSI based on the reference signal received from Tx and transmit the estimated CSI and the resource information of Rx to the third device. As an example, Rx-resource information may include at least any one or more of network type information, weights information, number of layers information, and activation function information of Rx.

Next, as the third device is a device that has a neural network and learning capability, as described, the third device may perform learning based on the Tx-resource information received from Tx, the Rx-resource information received from Rx, and CSI. More specifically, the third device may have an autoencoder. Herein, the autoencoder may perform learning for f(·) and g(·) by using at least any one of Tx-resource information, Rx-resource information and CSI. Next, the third device may transmit f(·), which is derived through learning, to Tx. In addition, the third device may transmit g(·), which is derived through learning, to Rx. Next, Tx may generate data that is encoded through f(·) obtained from the third device. Next, a modulator of Tx may perform operations of rate matching, waveform, framing, and analog front. That is, Tx may transmit data, which is encoded based on f(·), to Rx through the channel h(·) after a modulation process (S3880). Next, Rx may receive a signal transmitted by Tx (S3890). At this time, a demodulator of Rx may perform, for the received signal, functions of an analog digital converter (ADC), a radio frequency (RF) front operation like automatic gain control (AGC), synchronization and equalization. That is, Rx may generate LLR for input of g(·) through demodulation of the received signal. Then, Rx may perform decoding based on g(·) information, which is received from the third device, and reconstruct data.

Herein, as an example, the autoencoder may train f and g by reflecting CSI(h), and this is the same as described above. Herein, the autoencoder may consider a case in which channel state information h is assumed as an ideal channel. Herein, Tx may not transmit a reference signal to Rx. That is, the above-described operations S3810 and S3820 may not be needed. Herein, Tx may transmit resource information of Tx to the third device. In addition, Rx may transmit resource information of Rx to the third device. Herein, the third device may train f(·) and g(·) based on information that is obtained from Tx and Rx through the autoencoder, and this is the same as described above.

Meanwhile, as an example, in the above-described case, Tx and Rx may be at least any one of a base station, a terminal, and a device of FIG. 4 to FIG. 9. In addition, as an example, Rx may be any one of a base station, a terminal, and a device of FIG. 4 to FIG. 9. That is, for convenience of explanation, they are described as Tx and Rx in the above description, and Tx and Rx may not be limited to a particular device.

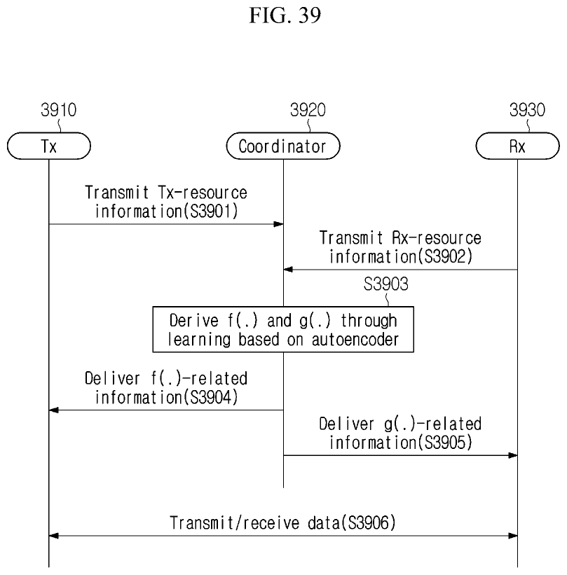

FIG. 39 is a view showing a method of configuring an autoencoder at a coordinator that is applicable to the present disclosure.

Referring to FIG. 39, Tx 3910 and Rx 3930 may be a device with a neural network but without learning capability. Herein, as an example, a third device (coordinator) 3920 may be a device that has a neural network and performs learning based on learning capability.

Herein, as an example, learning of channel coding for Tx 3910 and Rx 3930 may be performed in the third device 3920, and this may be the same as in FIG. 38.

Herein, it is possible to consider a case in which Tx 3910 and Rx 3930 perform communication based on the control of the third device 3920. As an example, each of Tx 3910 and Rx 3930 may have capability based on the above-described Table 10. However, when Tx 3910 and Rx 3930 perform communication based on the control of the third device 3920, Tx 3910 and Rx 3930 may be set to a device based on the level 2 of Table 10. More specifically, when Tx 3910 and Rx 3930 perform communication based on the control of the third device 3920, it is desirable that learning for channel coding of Tx 3910 and Rx 3930 is performed in the third device 3920. In consideration of what is described above, when Tx 3910 and Rx 3930 perform communication based on the third device 3920, Tx 3910 and Rx 3930 may not exchange capability information based on the above-described Table 10, and a device of level 2 may be set as a default value.

As a more concrete example, it is possible to consider a case in which Tx 3910 and Rx 3930 are terminals and the third device 3920 is a base station. Herein, as terminal-to-terminal communication can be performed under the control of a base station, learning for channel coding may be performed in the base station but not in the terminals in consideration of power consumption and the like.

However, what is described above is only one example, and the present disclosure is not limited to the above-described embodiment.

As an example, Tx 3910 and Rx 3930 may exchange capability information with each other. Herein, when neither Tx 3910 nor Rx 3930 has learning capability, at least any one of Tx 3910 and Rx 3930 may transmit a request message for channel coding learning to the third device 3920. Herein, the third device 3920 may perform, based on the request message, learning for channel coding of Tx 3910 and Rx 3920, but is not limited to the above-described embodiment.

As another example, Tx 3910 and Rx 3930 may transmit capability information to the third device 3920. Herein, the third device 3920 may determine, based on capability information of Tx 3910 and Rx 3930, whether or not to perform learning for channel coding. Herein, when the third device 3920 determines to perform learning, the third device 3920 may operate by receiving information from Tx 3910 and Rx 3920, and this is the same as described in FIG. 38.

Herein, referring to FIG. 39, Tx 3910 may transmit Tx-resource information to the third device 3920 (S3901). Herein, Tx-resource information may include at least any one or more of network type information, weights information, number of layers information, and activation function information of Tx. In addition, Rx 3930 may transmit Rx-resource information to the third device 3920 (S3902). Herein, as in FIG. 38, when Tx 3910 and Rx 3930 perform channel estimation based on a reference signal, Rx 3930 may transmit Rx-resource information and CSI to the third device 3920, and this is the same as described above. Next, the third device 3920 may derive f(·) for encoding and g(·) for decoding through learning based on an autoencoder (S3903). Herein, when the third device 3920 obtains h(·) information based on CSI, the autoencoder may train f(·) and g(·) by using h(·) information. Next, the third device 3920 may deliver f(·)-related information to Tx 3910 (S3904). In addition, the third device 3920 may deliver g(·)-related information to Rx 3930 (S3905). Next, Tx 3910 and Rx 3930 may perform data communication based on trained f(·) and g(·), and this is the same as described above.

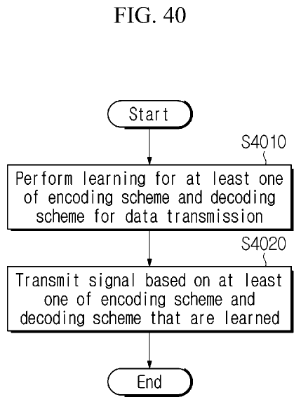

FIG. 40 is a view showing a method of operating a terminal that is applicable to the present disclosure. As an example, the description below focuses on a terminal but, as described above, this may be applied likewise to a base station and a device of FIG. 4 to FIG. 9. However, hereinafter, for convenience of explanation, description will focus on a terminal.

As an example, a terminal may perform learning for at least any one of an encoding scheme and a decoding scheme for data transmission (S4010). In addition, the terminal may transmit a signal based on at least one of the learned encoding scheme and decoding scheme (S4020).

Herein, as an example, the terminal may operate based on terminal (UE) capability. As an example, in case the terminal is a first type terminal, the terminal may operate based on a fixed channel coding scheme. That is, the terminal may use a conventional coding scheme without a neural network and correspond to the level 1 device of Table 10 described above. In addition, as an example, in case the terminal is a second type terminal, the terminal may have a neural network. However, the terminal may not have CPU or GPU and not have learning capability in consideration of power consumption. That is, the terminal may operate based on a neural network but not have learning capability and correspond to the level 2 device of Table 10. In addition, as an example, in case the terminal is a third type terminal, the terminal may have a neural network and perform learning for channel coding. That is, the terminal may derive an optimal encoding scheme and decoding scheme through learning. Herein, the terminal may correspond to the level 3 device of Table 10.

Herein, as described in FIG. 30 and FIG. 31, it is possible to consider a case in which the terminal as a third type terminal transmits a signal. Herein, the terminal may transmit a reference signal to Rx and receive at least any one of CSI and Rx-resource information from Rx. Herein, as an example, Rx-resource information is the same as described in FIG. 30 and FIG. 31. Based on the above-described information, the terminal may perform learning for at least any one of an encoding scheme and a decoding scheme for channel coding. Then, the terminal may deliver information on the learned decoding scheme to Rx and transmit a signal to Rx based on the learned encoding scheme.

In addition, as an example, as described in FIG. 32 and FIG. 33, in case the terminal is a third type terminal and is a terminal receiving a signal, the terminal may obtain CSI based on a reference signal and receive resource information of Tx from Tx. Next, the terminal may learn at least any one of an encoding scheme and a decoding scheme based on at least any one of the resource information of Tx and CSI. Herein, the terminal may deliver information on the learned encoding scheme to Tx and receive a signal that is encoded by the scheme. The terminal may perform decoding for a signal that is received based on the learned decoding scheme.

In addition, as an example, as described in FIG. 36 and FIG. 37, it is possible to consider a case in which a terminal is a third type terminal and is a terminal transmitting a signal. However, Rx may uses a fixed decoding scheme. That is, Rx may be a device corresponding to level 1 in Table 10. Herein, the terminal may obtain CSI and information on the fixed decoding scheme. Herein, the terminal may perform learning for an encoding scheme based on at least any one of CSI and information on the fixed decoding scheme.

In addition, the terminal may transmit a signal to Rx based on the learned encoding scheme. Herein, Rx may decode the received signal based on the fixed decoding scheme, and this is the same as described above.

In addition, as an example, as described in FIG. 34 and FIG. 35, it is possible to consider a case in which a terminal is a third type terminal and is a terminal receiving a signal. Herein, Tx may use a fixed encoding scheme. That is, Tx may be a device corresponding to level 1 in Table 10 described above. Herein, the terminal may obtain CSI and information on the fixed encoding scheme. The terminal may perform learning for a decoding scheme based on at least any one of CSI and information on the fixed encoding scheme. Then, the terminal may perform decoding for a signal that is received based on the learned decoding scheme. On the other hand, Tx may transmit a signal to the terminal based on the fixed encoding scheme.

In addition, as described in FIG. 38 and FIG. 39, it is possible to consider a case in which a terminal is a third type terminal and is a coordinator terminal. In addition, as an example, it may be applied likewise to a base station. Herein, the terminal may obtain information on at least any one of resource information of Tx, resource information of Rx, and CSI of Tx and Rx. Next, based on the obtained information, the terminal may learn at least any one of an encoding scheme of Tx and a decoding scheme of Rx. Herein, the terminal may transmit, to Tx, information on the learned encoding scheme of Tx, and transmit, to Rx, information on the learned decoding scheme of Rx. Next, Tx and Rx may perform data exchange based on information obtained from the terminal. In addition, as an example, the terminal may be a terminal that communicates with at least one of a moving terminal, a network, and an autonomous vehicle apart from a vehicle including the terminal, but is not limited to the above-described embodiment. In addition, as an example, when an autoencoder is applied to communication, signaling may be performed in pairing or connection of devices in order to recognize AI capability. As an example, signaling may be performed based on at least any one of RRC, MIB, SIB and CCH. In addition, as an example, devices may recognize neural network resources between each other. That is, during pairing or connection of devices, at least any one or more of “NN performance,” “#of layer,” “possible network type” and “# of nodes”, which the devices are capable of implementing, may be synchronized.

As another example, Tx and Rx perform learning by exchanging learning data, and this may cause the waste of resources. Accordingly, any one of Tx and Rx may be configured as a “On Device AE”, and this is the same as described above. Meanwhile, as an example, the above-described information may be implemented through CCH.

In addition, as an example, a device may have various restrictions on implementation complexity. As an example, at least any one or more of a high-price terminal, a low-price terminal, a low-power IoT product, a small base station, a repeater, and a power consumption-restricted terminal may be used. Herein, as an example, when a neural network encoder/decoder is to be implemented based on a communication purpose, the number of layers, a filter length, and quantization bit-width may be used in each device based on restrictions.

Accordingly, devices may have different resources or use different parameters for encoding/decoding, and this may need to be implemented, as described above.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered illustrative. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

1. A method for operating user equipment (UE) in a wireless communication system, the method comprising:
performing learning for at least one of an encoding scheme and a decoding scheme for data transmission based on UE capability, wherein a type of UE is any one of a first type UE, a second type UE and a third type UE;
generating at least one codeword by encoding information bits based on the encoding scheme,
generating modulation symbols based on the at least one codeword; and
transmitting a signal including the modulation symbols,
wherein, based on the UE being the third type UE, the UE obtains channel state information (CSI) and information on the fixed decoding scheme from a receiving end (Rx), and
wherein the UE performs learning for the encoding scheme based on at least one of the CSI and the information on the fixed decoding scheme.

2. The method of claim 1,
wherein, based on the UE being the first type UE, the UE operates based on a fixed channel coding scheme,
wherein, based on the UE being the second type UE, the UE has a neural network but does not perform learning for channel coding, and
wherein, based on the UE being the third type UE, the UE has a neural network and performs learning for channel coding.

3. The method of claim 1, wherein, based on the UE being the third type UE and being UE that transmits a signal, the UE receives, from the Rx, at least one of the CSI and resource information of the Rx,
wherein the UE performs learning at least one of the encoding scheme and the decoding scheme based on the received information, and
wherein the UE transmits the signal based on the learned encoding scheme.

4. The method of claim 3, wherein the UE transmits information on the learned decoding scheme to the Rx, and
wherein the Rx performs decoding for the signal, which is transmitted from the UE based on the learned encoding scheme, based on information on the learned decoding scheme.

5. The method of claim 1, wherein, based on the UE being the third type UE and being UE that receives a signal, the UE obtains the CSI based on a reference signal and receives resource information of a transmitting end (Tx) from the Tx,
wherein the UE performing learning at least one of the encoding scheme and the decoding scheme based on the resource information of the Tx and the CSI, and
wherein the UE receives the signal based on the learned decoding scheme.

6. The method of claim 5, wherein the UE transmits information on the learned encoding scheme to the Tx, and
wherein the Tx performs encoding for data to be transmitted to the UE based on information on the learned encoding scheme.

7. (canceled)

8. The method of claim 1, wherein the UE transmits the signal to the Rx based on the learned encoding scheme, and
wherein the Rx decodes the received signal based on the fixed decoding scheme.

9-12. (canceled)

13. User equipment (UE) operating in a wireless communication system, the UE comprising:
at least one transmitter;
at least one receiver;
at least one processor; and
at least one memory that is coupled with the at least one processor in an operable manner and stores instructions which, when being executed, enable the at least one processor to perform a specific operation,
wherein the specific operation is configured to:
perform learning for at least one of an encoding scheme and a decoding scheme for data transmission based on UE capability, wherein a type of UE is any one of a first type UE, a second type UE and a third type UE,
generate at least one codeword by encoding information bits based on the encoding scheme,
generate modulation symbols based on the at least one codeword, and
transmit a signal including the modulation symbols,
wherein, based on the UE being the third type UE, the UE obtains channel state information (CSI) and information on the fixed decoding scheme from a receiving end (Rx), and
wherein the UE performs learning for the encoding scheme based on at least one of the CSI and the information on the fixed decoding scheme.

14. The user equipment of claim 13, wherein the user equipment communicates with at least one of a moving terminal, a network, and an autonomous vehicle apart from a vehicle including the user equipment.
